(19) United States
(12) Patent Application Publication
(10) Pub. No.: US 2020/0190404 A1
(43) Pub. Date: Jun. 18, 2020

(54) LIQUID CRYSTAL COMPOSITION AND DEVICE USED FOR PHASE CONTROL OF ELECTROMAGNETIC WAVE SIGNAL

(71) Applicants: JNC CORPORATION, Tokyo (JP); JNC PETROCHEMICAL CORPORATION, Tokyo (JP)

(72) Inventor: Eiji OKABE, Chiba (JP)

(73) Assignees: JNC CORPORATION, Tokyo (JP); JNC PETROCHEMICAL CORPORATION, Tokyo (JP)

(21) Appl. No.: 16/590,384

(22) Filed: Oct. 2, 2019

(30) Foreign Application Priority Data
Dec. 13, 2018 (JP) 2018-233358
Aug. 27, 2019 (JP) 2019-154672

(51) Int. Cl. C09K 19/34; C09K 19/30; C09K 19/58; C09K 19/54

(52) U.S. Cl. CPC C09K 19/3491; C09K 19/3059; C09K 2019/0466; C09K 19/586; C09K 19/542; C09K 19/3402

(57) ABSTRACT

As a material to be used in a device used for phase control of an electromagnetic wave signal with a frequency of 1 MHz to 400 THz, a liquid crystal composition having a high maximum temperature of a nematic phase, a low minimum temperature of the nematic phase, large optical anisotropy, small dielectric loss, and thermal stability in a frequency range used for phase control and having good balance between characteristics is required. A liquid crystal composition used for phase control of an electromagnetic wave signal with any frequency of 1 MHz to 400 THz containing at least one compound selected from a group consisting of compounds represented by formula (1) and at least one compound selected from a group consisting of compounds represented by formula (2).

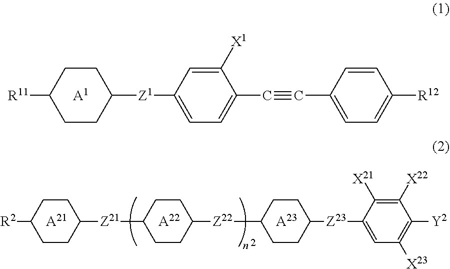

### CROSS-REFERENCE TO RELATED APPLICATION

This application claims the priority benefit of Japan application serial no. 2018-233358, filed on Dec. 13, 2018, and the priority benefit of Japan application serial no. 2019-154672, filed on Aug. 27, 2019. The entirety of the above-mentioned patent applications is hereby incorporated by reference herein and made a part of this specification.

### BACKGROUND

### Technical Field

The present disclosure relates to a device used for phase control of electromagnetic wave signals with a frequency of 1 MHz to 400 THz and a liquid crystal composition used for the device.

### Description of Related Art

Examples of the device used for phase control of electromagnetic wave signals with a frequency of 1 MHz to 400 THz include millimeter wave band or microwave band antennas, infrared laser devices, and the like. Although various methods for those devices have been discussed, a method using liquid crystal which is assumed will have few failures for the reason that it has no mechanical movable parts has gained attention.

A liquid crystal has a molecular orientation changing according to a bias electric field applied from outside and thus has a changing dielectric constant. Using this property, for example, a microwave device that can electrically control transmission characteristics of high frequency transmission lines from outside can be realized. Reported examples of such devices are voltage-controlled millimeter wave band variable phase shifters having a waveguide filled with a nematic liquid crystal, microwave and millimeter wave wide band variable phase shifters using a nematic liquid crystal as a dielectric substrate for microstrip lines, and the like (see Patent Documents 1 and 2).

A liquid crystal composition used for such a conventional device is disclosed in Patent Documents 3 and 4 described below.

### PATENT DOCUMENTS

[Patent Document 1] WO 2017/201515

[Patent Document 2] US Publication No. 2018/0239213

[Patent Document 3] Japanese Patent Laid-Open No. 2004-285085

[Patent Document 4] Japanese Patent Laid-Open No. 2011-74074

### SUMMARY

It is desirable for such a device used for phase control of electromagnetic wave signals to have a wide range of applicable temperatures and characteristics such as high gain and low loss. Thus, liquid crystal compositions are required to have characteristics of a high maximum temperature of a nematic phase, a low minimum temperature of the nematic phase, a low viscosity, large optical anisotropy, large dielectric anisotropy, small dielectric loss, a high specific resistance in a drive frequency range, thermal stability, and the like in a frequency range used for phase control.

The disclosure provides a liquid crystal composition having the above-described required favorable characteristics and good balance between characteristics as a material for a device used for phase control of electromagnetic wave signals with a frequency of 1 MHz to 400 THz.

As a result of vigorous examination, the inventors have found out that a liquid crystal composition including a liquid crystal compound having a specific structure can solve the above-described problems and thereby completed the present disclosure.

The present disclosure includes the following configuration.

Item 1. A liquid crystal composition containing at least one compound selected from a group consisting of compounds represented by formula (1) and at least one compound selected from a group consisting of compounds represented by formula (2) and is used for phase control of an electromagnetic wave signal with any frequency of 1 MHz to 400 THz.

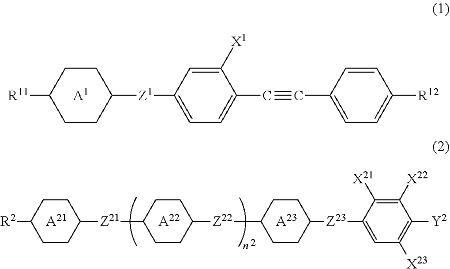

In formula (1) and formula (2), R¹¹, R¹² and R² are each independently alkyl having one to twelve carbon atoms, alkoxy having one to twelve carbon atoms, alkenyl having two to twelve carbon atoms, or alkoxyalkyl having two to twelve carbon atoms; rings A¹, A²¹, A²² and A²³ are each independently 1,4-cyclohexylene, 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl, or tetrahydropyran-2,5-diyl; Z′, Z²¹, Z²² and Z²³ are each independently a single bond, ethylene, vinylene, methyleneoxy, carbonyloxy, difluoromethyleneoxy, ethynylene, or tetrafluoroethylene, wherein at least one of Z²¹, Z²² and Z²³ is difluoromethyleneoxy; X¹, X²¹, X²² and X²³ are each independently hydrogen or fluorine, wherein X²¹ and X²² are not fluorine at the same time; Y² is fluorine, chlorine, alkyl having one to twelve carbon atoms in which at least one hydrogen atom may be replaced by a halogen, alkoxy having one to twelve carbon atoms in which at least one hydrogen atom may be replaced by a halogen, or alkenyl having two to twelve carbon atoms in which at least one hydrogen atom may be replaced by a halogen; and n² is 1 or 2, and in a case in which n² is 2, plural rings A²² and Z²² may be the same or different.

Item 2. The liquid crystal composition according to Item 1, containing at least one compound selected from a group consisting of compounds represented by formula (1-1) to formula (1-13).

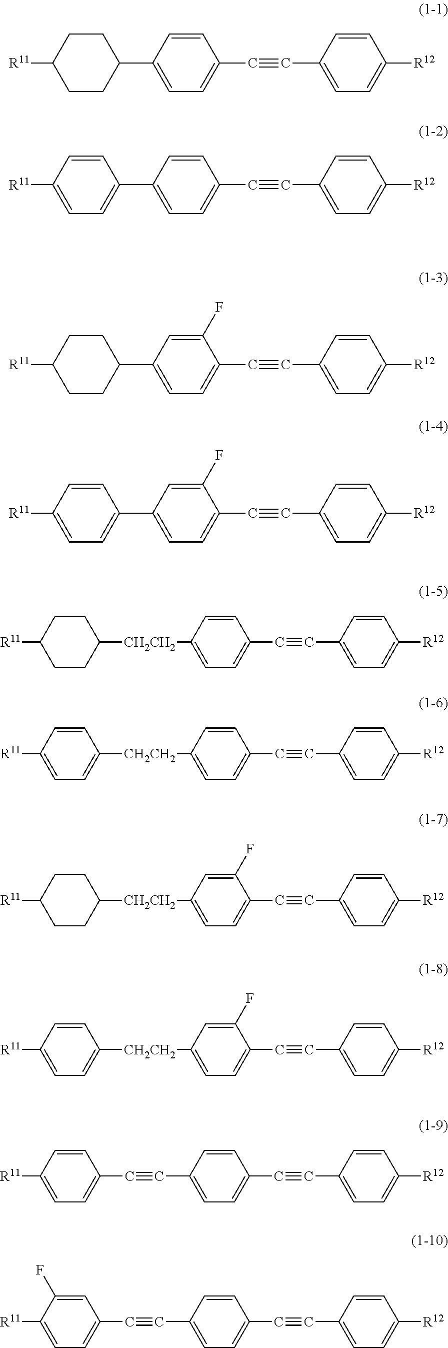

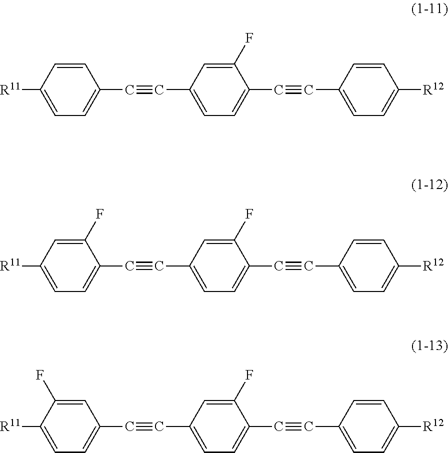

In the formulas, R¹¹ and R¹² are each independently alkyl having one to twelve carbon atoms, alkoxy having one to twelve carbon atoms, or alkenyl having two to twelve carbon atoms.

Item 3. The liquid crystal composition according to Item 1 or 2, in which a proportion of the compound represented by formula (1) according to Item 1 is in a range of 10% by weight to 70% by weight based on a weight of the liquid crystal composition.

Item 4. The liquid crystal composition according to any one of Items 1 to 3, containing at least one compound selected from a group consisting of compounds represented by formula (2-1) to formula (2-15).

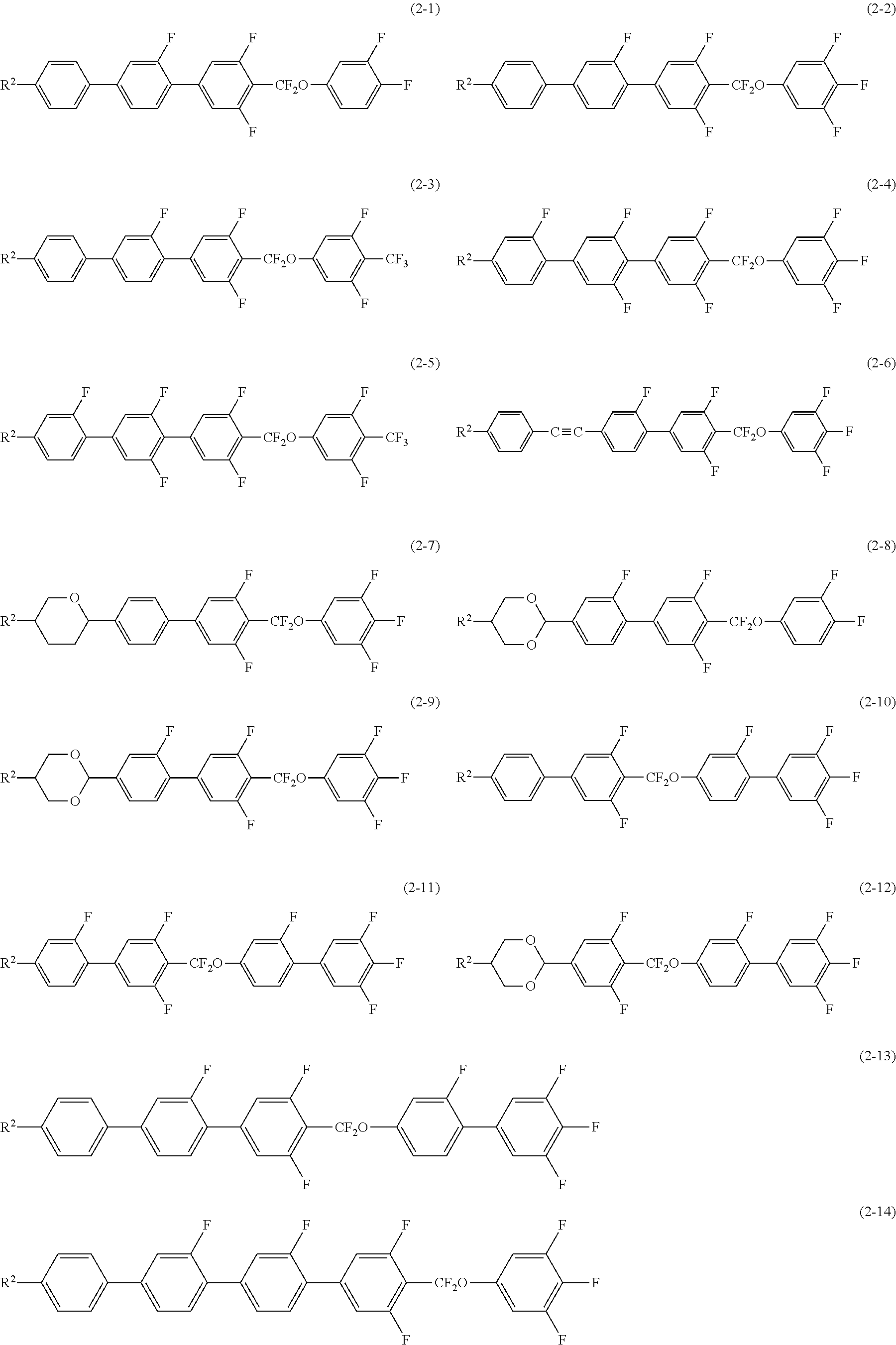

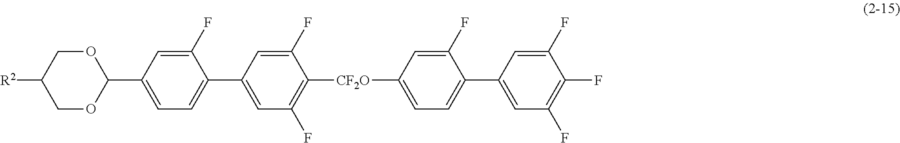

In the formulas, R² is alkyl having one to twelve carbon atoms, alkoxy having one to twelve carbon atoms, alkenyl having two to twelve carbon atoms, or alkoxyalkyl having a total of two to twelve carbon atoms.

Item 5. The liquid crystal composition according to any one of Items 1 to 4, in which a proportion of the compound represented by formula (2) according to Item 1 is in a range of 5% by weight to 55% by weight based on a weight of the liquid crystal composition.

Item 6. The liquid crystal composition according to any one of Items 1 to 5, further containing at least one compound selected from a group consisting of compounds represented by formula (3).

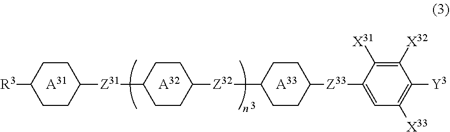

In formula (3), R³ is alkyl having one to twelve carbon atoms, alkoxy having one to twelve carbon atoms, or alkenyl having two to twelve carbon atoms; ring A³¹, ring A³², and ring A³³ are each independently 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl, or tetrahydropyran-2,5-diyl; Z³¹, Z³², and Z³³ are each independently a single bond, ethylene, vinylene, methyleneoxy, carbonyloxy, ethynylene, or tetrafluoroethylene; X³¹, X³², and X³³ are each independently hydrogen or fluorine, wherein X³¹ and X³² are not fluorine at the same time; Y³ is fluorine, chlorine, alkyl having one to twelve carbon atoms in which at least one hydrogen atom may be replaced by a halogen, alkoxy having one to twelve carbon atoms in which at least one hydrogen atom may be replaced by a halogen, or alkenyl having two to twelve carbon atoms in which at least one hydrogen atom may be replaced by a halogen; and n³ is 0, 1, or 2, and in a case in which n³ is 2, plural rings A³² and Z³² may be the same or different.

Item 7. The liquid crystal composition according to Item 6, containing at least one compound selected from a group consisting of compounds represented by formula (3-1) to formula (3-12).

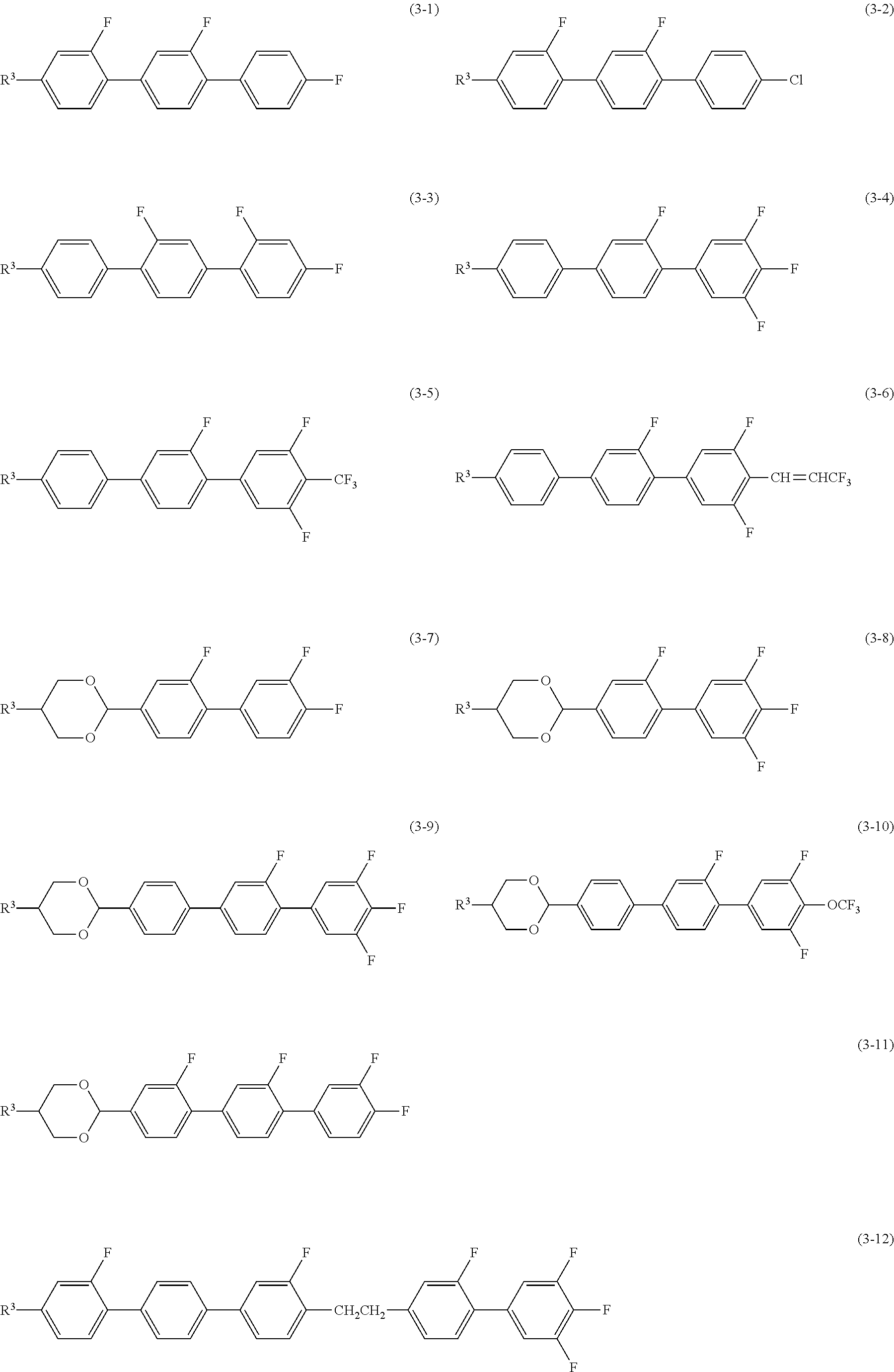

In the formulas, R³ is alkyl having one to twelve carbon atoms, alkoxy having one to twelve carbon atoms, or alkenyl having two to twelve carbon atoms.

Item 8. The liquid crystal composition according to Item 6 or 7, in which a proportion of the compound represented by formula (3) is in a range of 3% by weight to 40% by weight based on a weight of the liquid crystal composition.

Item 9. The liquid crystal composition according to any one of Items 1 to 8, further containing at least one compound selected from a group consisting of compounds represented by formula (4).

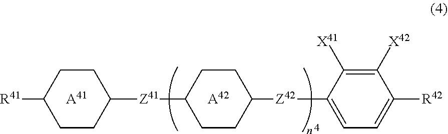

In formula (4), R⁴¹ and R⁴² are each independently alkyl having one to twelve carbon atoms, alkoxy having one to twelve carbon atoms, or alkenyl having two to twelve carbon atoms; ring A⁴¹ and ring A⁴² are each independently 1,4-cyclohexylene, 1,4-phenylene, 2-fluoro-1,4-phenylene, 2,5-difluoro-1,4-phenylene, 2,6-difluoro-1,4-phenylene, or 2,6-benzothiophene; Z⁴¹ is a single bond, ethylene, vinylene, methyleneoxy, carbonyloxy, difluoromethyleneoxy, ethynylene, or tetrafluoroethylene; Z⁴² is a single bond, ethylene, vinylene, methyleneoxy, carbonyloxy, difluoromethyleneoxy, or tetrafluoroethylene; X⁴¹ and X⁴² are each independently hydrogen or fluorine, wherein X⁴¹ and X⁴² are not fluorine at the same time; and n⁴ is 0, 1, or 2, in a case in which n⁴ is 1 or 2, Z⁴¹ is not ethynylene, and in a case in which n⁴ is 2, plural rings A⁴² and Z⁴² may be the same or different.

Item 10. The liquid crystal composition according to Item 9, containing at least one compound selected from a group consisting of compounds represented by formula (4-1) to formula (4-20).

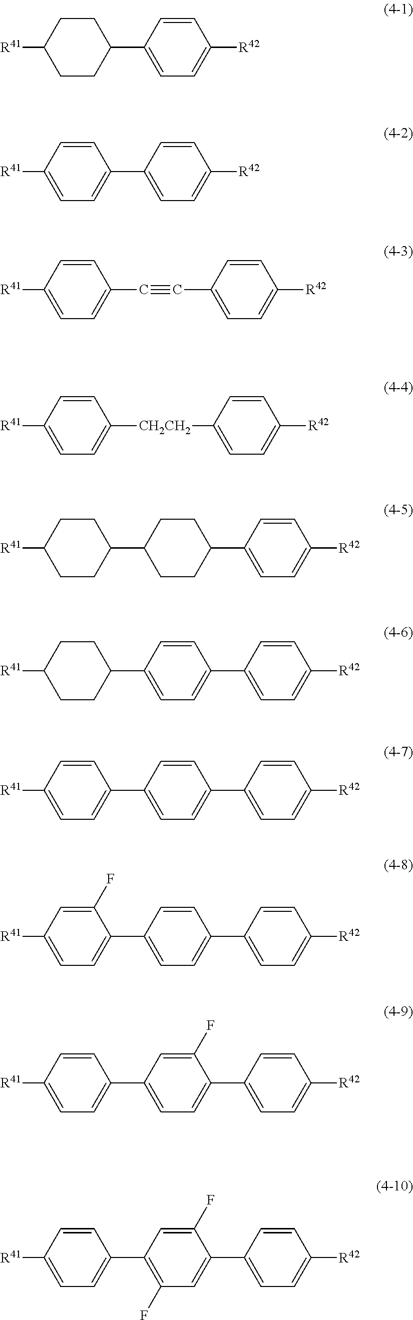

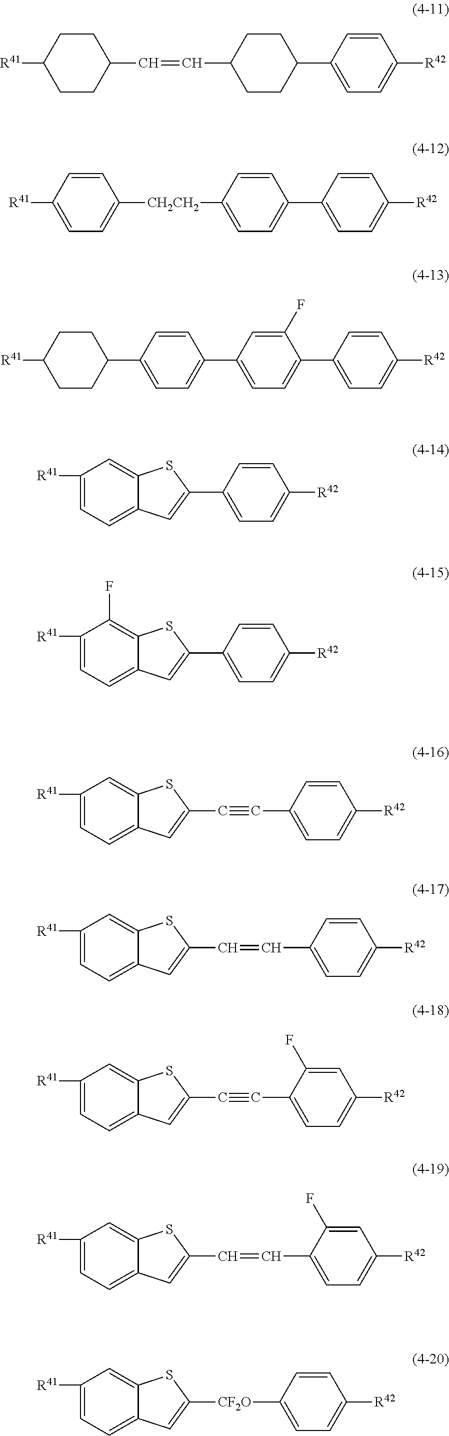

In the formulas, R⁴¹ and R⁴² are each independently alkyl having one to twelve carbon atoms, alkoxy having one to twelve carbon atoms, or alkenyl having two to twelve carbon atoms.

Item 11. The liquid crystal composition according to Item 9 or 10, in which a proportion of the compound represented by formula (4) is in a range of 10% by weight to 70% by weight based on a weight of the liquid crystal composition.

Item 12. The liquid crystal composition according to any one of Items 1 to 11, in which an optical anisotropy at a wavelength of 589 nm and a temperature of 25° C. is in a range of 0.18 to 0.35, and a dielectric anisotropy at a frequency of 1 kHz and a temperature of 25° C. is in a range of 3 to 40.

Item 13. The liquid crystal composition according to any one of Items 1 to 12, in which an optical anisotropy at any frequency of 1 GHz to 50 GHz and a temperature of 25° C. is in a range of 0.10 to 0.40.

Item 14. The liquid crystal composition according to any one of Items 1 to 13, containing an optically active compound.

Item 15. The liquid crystal composition according to any one of Items 1 to 14, containing a polymerizable compound.

Item 16. A device used for phase control of an electromagnetic wave signal with any frequency of 1 MHz to 400 THz containing the liquid crystal composition according to any one of Items 1 to 15.

A composition of the present disclosure has characteristics of a high maximum temperature of a nematic phase, a low minimum temperature of the nematic phase, large optical anisotropy, small dielectric loss, and thermal stability in a frequency range used for phase control. Thus, a device using the material has good practical characteristics.

### DESCRIPTION OF THE EMBODIMENTS

Usage of terms in the present specification is as follows. The term “liquid crystal composition” may be abbreviated as a “composition.” At least one compound selected from a group consisting of compounds represented by formula (1) may be abbreviated as “Compound (1).” “Compound (1)” means one or two or more compounds represented by formula (1). The same applies to compounds represented by other formulas as well. “At least one” with respect to “may be replaced” means that an atom can be selected without restriction on not only a position but also the number.

A liquid crystal composition is prepared by mixing a plurality of liquid crystalline compounds. A proportion (content) of a liquid crystalline compound is indicated by a weight percentage based on a weight of the liquid crystal composition (% by weight). Any additive such as an optically active compound, an antioxidant, a UV absorber, a dye, a defoamer, a polymerizable compound, a polymerization initiator, and a polymerization inhibitor may be added to the liquid crystal composition if necessary. A proportion of the additive (addition amount) is indicated by a weight percentage based on a weight of the liquid crystal composition (% by weight), similarly to a proportion of a liquid crystalline compound. Parts per million by weight (ppm) may also be used. Exceptionally, a proportion of polymerization initiator and polymerization inhibitor is indicated based on a weight of a polymerizable compound.

The “maximum temperature of a nematic phase” may be abbreviated as a “maximum temperature.” A “minimum temperature of a nematic phase” may be abbreviated as a “minimum temperature.” That “specific resistance is high” means that a composition has a high specific resistance not only at room temperature but also at a temperature close to the maximum temperature of the nematic phase in an initial stage and has a high specific resistance not only at room temperature but also at a temperature close to the maximum temperature of the nematic phase after use for a long period of time.

The phrase “at least one “A” may be replaced by “B”” includes that the number of “A”s is arbitrary. In a case in which the number of “A”s is one, a position of “A” is arbitrary, and even in a case in which the number of “A”s is two or greater, positions thereof can be selected without restriction. This rule also applies to the phrase “at least one “A” has been replaced by “B”.”

In chemical formulas of component compounds, the symbol of the end group R¹¹ is used in a plurality of compounds. In those compounds, two groups represented by two arbitrary R¹¹'s may be the same or different. For example, there may be a case in which R¹¹ of Compound (1-1) is ethyl and R¹¹ of Compound (1-2) is ethyl. There also may be a case in which R¹¹ of Compound (1-1) is ethyl and R¹¹ of compound (1-2) is propyl. This rule also applies to the symbols of R¹², R², R³, R⁴¹, R⁴², and the like. In formula (2), when n² is 2, there are two rings A²². In this compound, the two rings represented by the two rings A²² may be the same or different. This rule also applies to Z²², ring A³², Z³², ring A⁴², Z⁴², and the like.

2-Fluoro-1,4-phenylene means the following two bivalent groups. In a chemical formula, fluorine may be oriented to the left (L) or to the right (R). This rule also applies to asymmetric ring bivalent groups such as 2,5-difluoro-1,4-phenylene, 2,6-difluoro-1,4-phenylene, pyridine-2,5-diyl, pyrimidine-2,5-diyl, 1,3-dioxane-2,5-diyl, and tetrahydropyran-2,5-diyl.

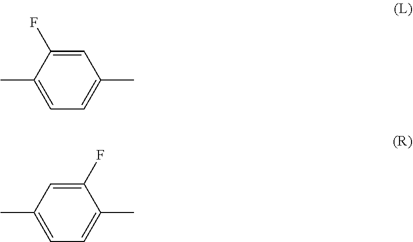

The present disclosure includes the following items. (a) A composition further containing at least one additive such as an optically active compound, an antioxidant, a UV absorber, a dye, a defoamer, a polymerizable compound, a polymerization initiator, and a polymerization inhibitor. (b) A device containing the composition. (c) A device containing the composition and having a mode of PC, TN, STN, ECB, OCB, IPS, VA, FFS, or FPA. (d) The composition used as a composition having a nematic phase. (e) The composition used as an optically active composition by adding an optically active compound thereto.

Compositions of the present disclosure will be described in the following order. First, configurations of component compounds in the compositions will be described. Second, main characteristics of the component compounds and main effects of the compounds on the compositions will be described. Third, combinations of the components in the compositions, preferable proportions of the components, and the ground therefor will be described. Fourth, preferable forms of the component compounds will be described. Fifth, preferable component compounds will be introduced. Sixth, additives that may be added to the compositions will be described. Finally, applications of the compositions will be described.

First, configurations of component compounds in compositions will be described. Compositions of the present disclosure are divided into a composition A and a composition B. The composition A may further contain other liquid crystalline compounds, additives, and the like in addition to a liquid crystalline compound selected from Compounds (1), Compounds (2), Compounds (3), and Compounds (4). The “other liquid crystalline compounds” are liquid crystalline compounds different from Compounds (1), Compounds (2), Compounds (3), and Compounds (4). Such compounds are mixed into the compositions for the purpose of further adjusting characteristics. Additives include an optically active compound, an antioxidant, a UV absorber, a dye, a defoamer, a polymerizable compound, a polymerization initiator, a polymerization inhibitor, and the like.

The composition B substantially includes only a liquid crystalline compound selected from Compounds (1), Compounds (2), Compounds (3), and Compounds (4). “Substantially” means that the composition does not contain other liquid crystalline compounds although it may contain an additive. The composition B has a smaller number of components than the composition A. From the viewpoint of lowering costs, the composition B is more preferable than the composition A. From the viewpoint of being capable of further adjusting characteristics by mixing in other liquid crystalline compounds, the composition A is more preferable than the composition B.

Second, main characteristics of the component compounds and main effects of the compounds on characteristics of the compositions will be described. Main characteristics of the component compounds are summarized in Table 1 based on effects of the present disclosure. With respect to symbols in Table 1, L represents large or high, M represents medium, and S represents small or low. The symbols L, M, and S are results of classification based on qualitative comparison of the component compounds, and 0 (zero) means a value that is substantially or close to zero.

TABLE 1
Characteristics of compounds

| Compounds | (1) | (2) | (3) | (4) |
|---|---|---|---|---|
| Maximum | M to L | M to L | M to L | S to L |
| temperature | | | | |
| Viscosity | M | M to L | M to L | S to M |
| Optical | L | M to L | M to L | L |
| anisotropy | | | | |
| Dielectric | 0 | M to L | M to L | 0 |
| anisotropy | | | | |
| Specific | L | L | L | L |
| resistance | | | | |

The main effects of the component compounds on characteristics of the compositions when the component compounds are mixed into the compositions are as follows. Compounds (1) increase optical anisotropy. Compounds (2) increase dielectric anisotropy. Compounds (3) increase dielectric anisotropy. Compounds (4) increase optical anisotropy and raises the maximum temperature or lower the minimum temperature.

Third, combinations of the components in the compositions, preferable proportions of the component compounds, and grounds therefor will be described. Combinations of the components in the compositions include Compound (1)+Compound (2), Compound (1)+Compound (2)+Compound (3), Compound (1)+Compound (2)+Compound (4), or Compound (1)+Compound (2)+Compound (3)+Compound (4). Preferable combinations of the components in the composition include Compound (1)+Compound (2)+Compound (4) or Compound (1)+Compound (2)+Compound (3)+Compound (4), and a particularly preferable combination thereof is Compound (1)+Compound (2)+Compound (3)+Compound (4).

A preferable proportion of Compound (1) based on a weight of a liquid crystal composition is about 10% by weight or higher to increase optical anisotropy or to raise the maximum temperature, and is about 70% by weight or lower to increase dielectric anisotropy. A more preferable proportion thereof is in a range of about 10% by weight to about 60% by weight. A particularly preferable proportion thereof is in a range of about 10% by weight to about 50% by weight.

A preferable proportion of Compound (2) based on a weight of a liquid crystal composition is about 5% by weight or higher to increase dielectric anisotropy or to raise the maximum temperature, and is about 55% by weight or lower to increase optical anisotropy or to lower the minimum temperature. A more preferable proportion thereof is in a range of about 10% by weight to about 50% by weight. A particularly preferable proportion thereof is in a range of about 10% by weight to about 45% by weight.

A preferable proportion of Compound (3) based on a weight of a liquid crystal composition is about 3% by weight or higher to increase dielectric anisotropy or to raise the maximum temperature, and is about 40% by weight or lower to increase optical anisotropy or to lower the minimum temperature. A more preferable proportion thereof is in a range of about 3% by weight to about 30% by weight. A particularly preferable proportion thereof is in a range of about 3% by weight to about 20% by weight.

A preferable proportion of Compound (4) based on a weight of a liquid crystal composition is about 10% by weight or higher to increase optical anisotropy, to raise the maximum temperature, or to lower the minimum temperature, and is about 70% by weight or lower to increase dielectric anisotropy. A more preferable proportion thereof is in a range of about 10% by weight to about 65% by weight. A particularly preferable proportion thereof is in a range of about 15% by weight to about 65% by weight.

Fourth, preferable forms of the component compounds will be described. R¹¹, R¹², and R² are each independently alkyl having one to twelve carbon atoms, alkoxy having one to twelve carbon atoms, alkenyl having two to twelve carbon atoms, or alkoxyalkyl having two to twelve carbon atoms in total. Preferable R¹¹, R¹², and R² are alkyl having one to twelve carbon atoms to improve stability with respect to UV light or heat. R³, R⁴¹, and R⁴² are each independently alkyl having one to twelve carbon atoms, alkoxy having one to twelve carbon atoms, or alkenyl having two to twelve carbon atoms. Preferable R³, R⁴¹, and R⁴² are alkyls having one to twelve carbon atoms to improve stability with respect to UV light or heat.

Preferable alkyl is methyl, ethyl, propyl, butyl, pentyl, hexyl, heptyl, or octyl. More preferable alkyl is ethyl, propyl, butyl, pentyl, or heptyl for decreasing viscosity.

Preferable alkoxy is methoxy, ethoxy, propoxy, butoxy, pentyloxy, hexyloxy, or heptyloxy. More preferable alkoxy is methoxy or ethoxy for decreasing viscosity.

Preferable alkenyl is vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, or 5-hexenyl. More preferable alkenyl is vinyl, 1-propenyl, 3-butenyl, or 3-pentenyl for decreasing viscosity. A preferable steric configuration of —CH═CH— in the above alkenyl depends on a position of a double bond. Trans is preferred in alkenyl such as 1-propenyl, 1-butenyl, 1-pentenyl, 1-hexenyl, 3-pentenyl, and 3-hexenyl for decreasing viscosity or the like. Cis is preferred in alkenyl such as 2-butenyl, 2-pentenyl, and 2-hexenyl. Straight-chain alkenyl is preferable to branched alkenyl for alkenyl.

Preferable alkoxyalkyl is —CH₂OCH₃, —CH₂OC₂H₅, —CH₂OC₃H₇, —(CH₂)₂—OCH₃, —(CH₂)₂—OC₂H₅, —(CH₂)₂—OC₃H₇, —(CH₂)₃—OCH₃, —(CH₂)₄—OCH₃, and —(CH₂)₅—OCH₃.

n² is 1 or 2. Preferable n² is 1 for raising the maximum temperature or lowering the minimum temperature, or decreasing viscosity. n³ is 0, 1, or 2. A preferable n³ is 0 or 1 for raising the maximum temperature or lowering the minimum temperature, or decreasing viscosity. n⁴ is 0, 1, or 2. Preferable n⁴ is 0 for lowering the minimum temperature or decreasing viscosity.

Z¹ and Z⁴¹ are each independently a single bond, ethylene, vinylene, methyleneoxy, carbonyloxy, difluoromethyleneoxy, ethynylene, or tetrafluoroethylene. Preferably, Z¹ and Z⁴¹ are each independently a single bond for decreasing viscosity, and ethynylene for increasing optical anisotropy. Z⁴² is a single bond, ethylene, vinylene, methyleneoxy, carbonyloxy, difluoromethyleneoxy, or tetrafluoroethylene. A preferable Z⁴² is a single bond for decreasing viscosity. Z²¹, Z²², and Z²³ are each independently a single bond, ethylene, vinylene, methyleneoxy, carbonyloxy, difluoromethyleneoxy, ethynylene, or tetrafluoroethylene. Preferably, Z²¹, Z²², and Z²³ are each independently a single bond for decreasing viscosity, and difluoromethyleneoxy for increasing dielectric anisotropy. Z³¹, Z³², and Z³³ are each independently a single bond, ethylene, vinylene, methyleneoxy, carbonyloxy, ethynylene, or tetrafluoroethylene. Preferably, Z³¹, Z³², and Z³³ are each independently a single bond for decreasing viscosity and ethynylene for increasing optical anisotropy.

Ring A¹, ring A²¹, ring A²², and ring A²³ are each independently 1,4-cyclohexylene, 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl, or tetrahydropyran-2,5-diyl. Preferable ring A¹, ring A²¹, ring A²², and ring A²³ are each independently 1,4-phenylene, 2-fluoro-1,4-phenylene, 2,5-difluoro-1,4-phenylene, or 2,6-difluoro-1,4-phenylene for increasing optical anisotropy. Ring A³¹, ring A³², and ring A³³ are each independently 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl, or tetrahydropyran-2,5-diyl. Preferable ring A³¹, ring A³², and ring A³³ are each independently 1,4-phenylene, 2-fluoro-1,4-phenylene, 2,5-difluoro-1,4-phenylene, or 2,6-difluoro-1,4-phenylene for increasing optical anisotropy. Ring A⁴¹ and ring A⁴² are each independently 1,4-cyclohexylene, 1,4-phenylene, 2-fluoro-1,4-phenylene, 2,5-difluoro-1,4-phenylene, 2,6-difluoro-1,4-phenylene, or 2,6-benzothiophene. Preferable ring A⁴¹ and ring A⁴² are each independently 1,4-phenylene, 2-fluoro-1,4-phenylene, 2,5-difluoro-1,4-phenylene, or 2,6-difluoro-1,4-phenylene for increasing optical anisotropy. A steric configuration of 1,4-cyclohexylene is preferably trans rather than cis for raising the maximum temperature. Tetrahydropyran-2,5-diyl is

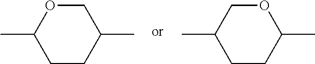

and preferably

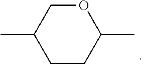

Although X¹, X²¹, X²², X²³, X³¹, X³², X³³, X⁴¹, and X⁴² are each independently hydrogen or fluorine, X²¹ and X²² are not fluorine at the same time, X³¹ and X³² are not fluorine at the same time, and likewise X⁴¹ and X⁴² are not fluorine at the same time. Preferable X¹, X²¹, X²², X²³, X³¹, X³², X³³, X⁴¹, and X⁴² are each independently fluorine for increasing dielectric anisotropy.

Y² and Y³ are each independently fluorine, chlorine, alkyl having one to twelve carbon atoms in which at least one hydrogen atom may be replaced by a halogen, alkoxy having one to twelve carbon atoms in which at least one hydrogen atom may be replaced by a halogen, or alkenyl having two to twelve carbon atoms in which at least one hydrogen atom may be replaced by a halogen. Preferable Y² and Y³ are fluorine for increasing dielectric anisotropy.

Fifth, preferable component compounds will be introduced. Preferable Compounds (1) include the following Compound (1-1) to Compound (1-13).

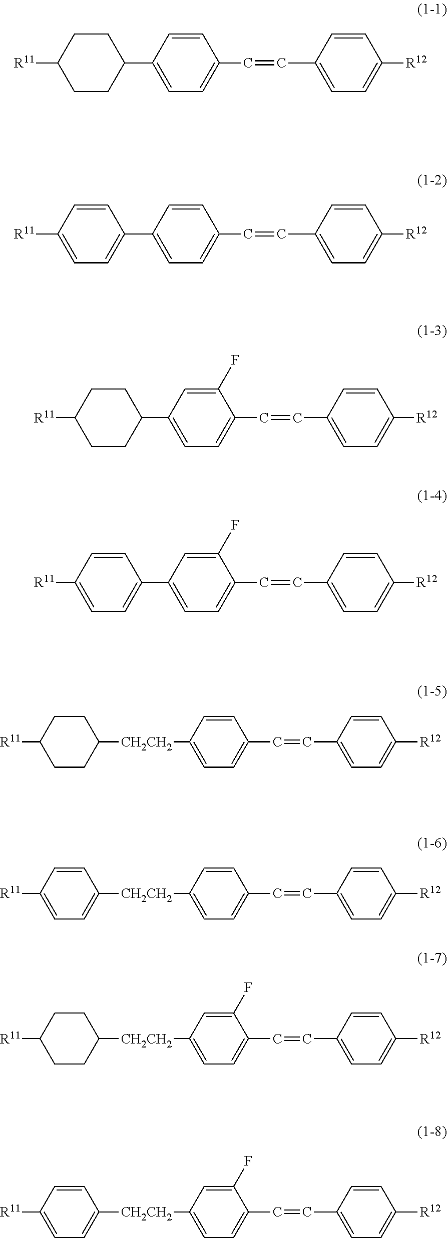

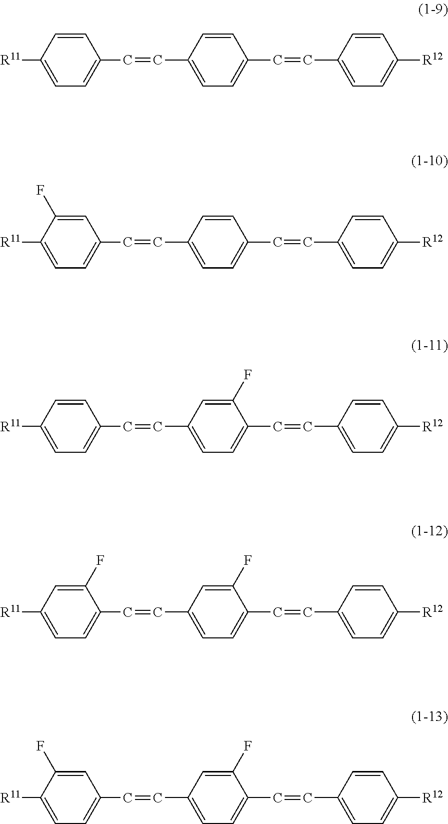

In the above compounds, at least one of Compounds (1) is preferably Compound (1-3), Compound (1-4), or Compound (1-5). At least two Compounds (1) are preferably combinations of Compound (1-3) and Compound (1-5) or Compound (1-4) and Compound (1-5).

Preferable Compounds (2) include the following Compound (2-1) to Compound (2-15).

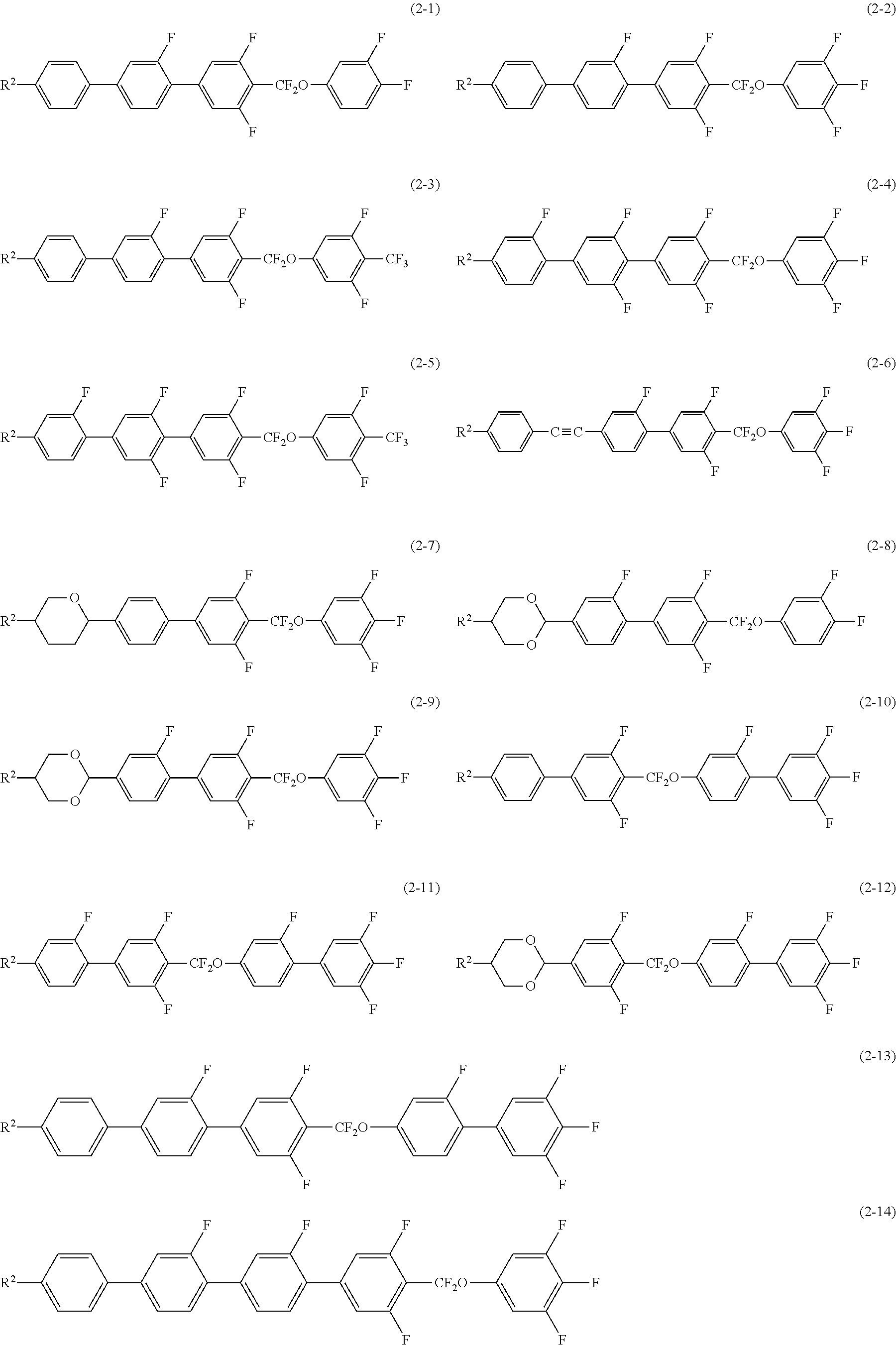

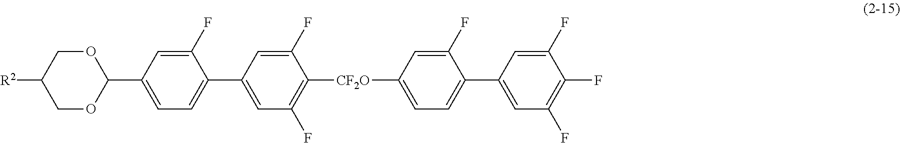

In the above compounds, at least one of Compounds (2) is preferably Compound (2-1), Compound (2-2), Compound (2-9), or Compound (2-10). At least two Compounds (2) are preferably combinations of Compound (2-1) and Compound (2-10), Compound (2-2) and Compound (2-10), or Compound (2-9) and Compound (2-10).

Preferable Compounds (3) include the following Compound (3-1) to Compound (3-12).

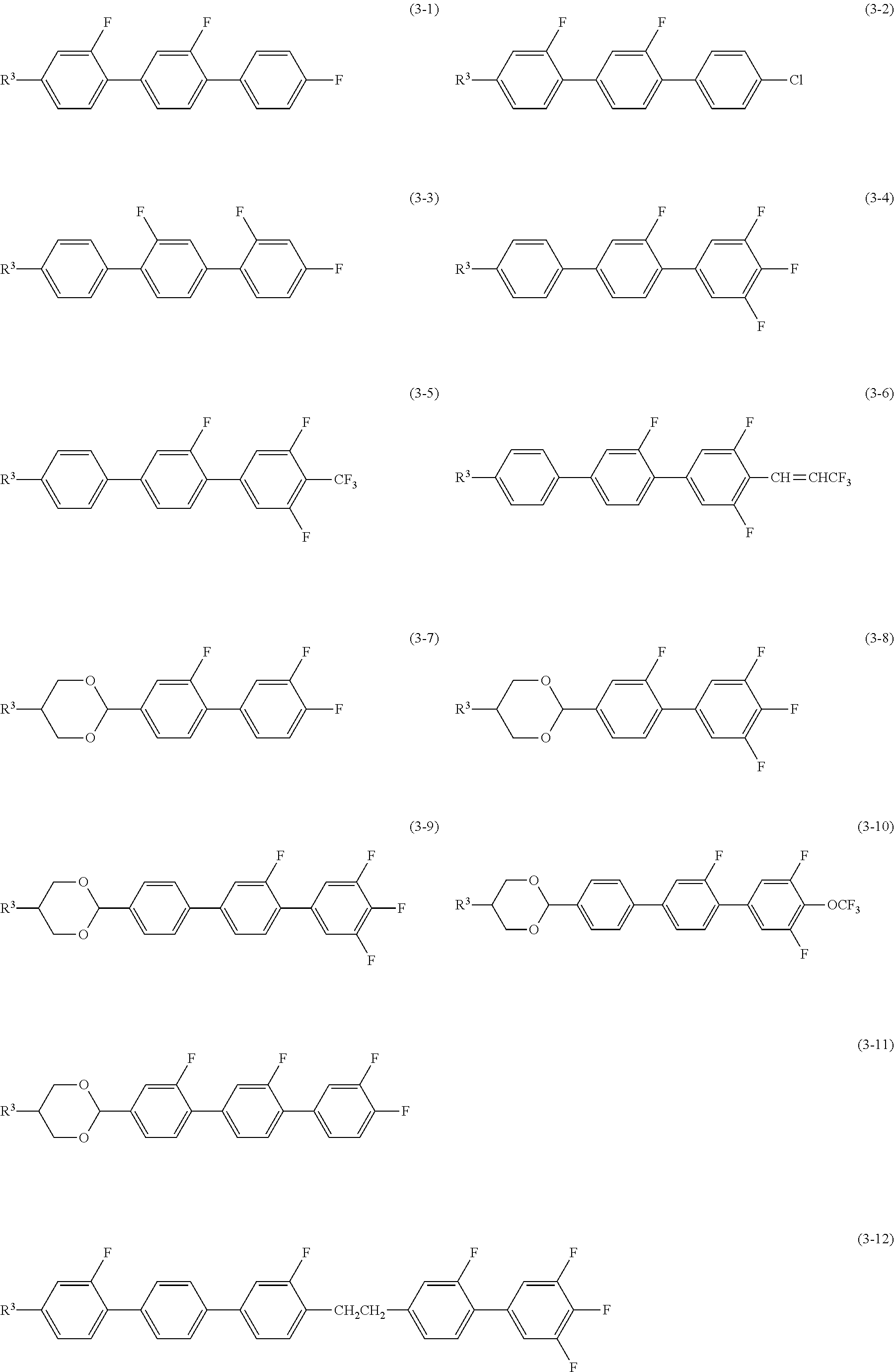

In the above compounds, at least one of Compounds (3) is preferably Compound (3-4) or Compound (3-5). At least two Compounds (3) are preferably a combination of Compound (3-4) and Compound (3-5).

Preferable Compounds (4) include the following Compound (4-1) to Compound (4-20).

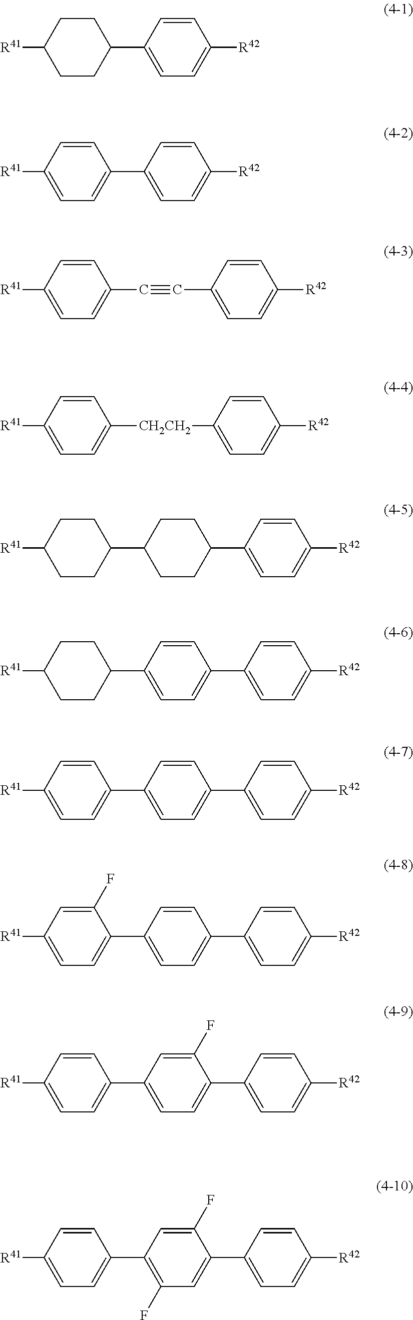

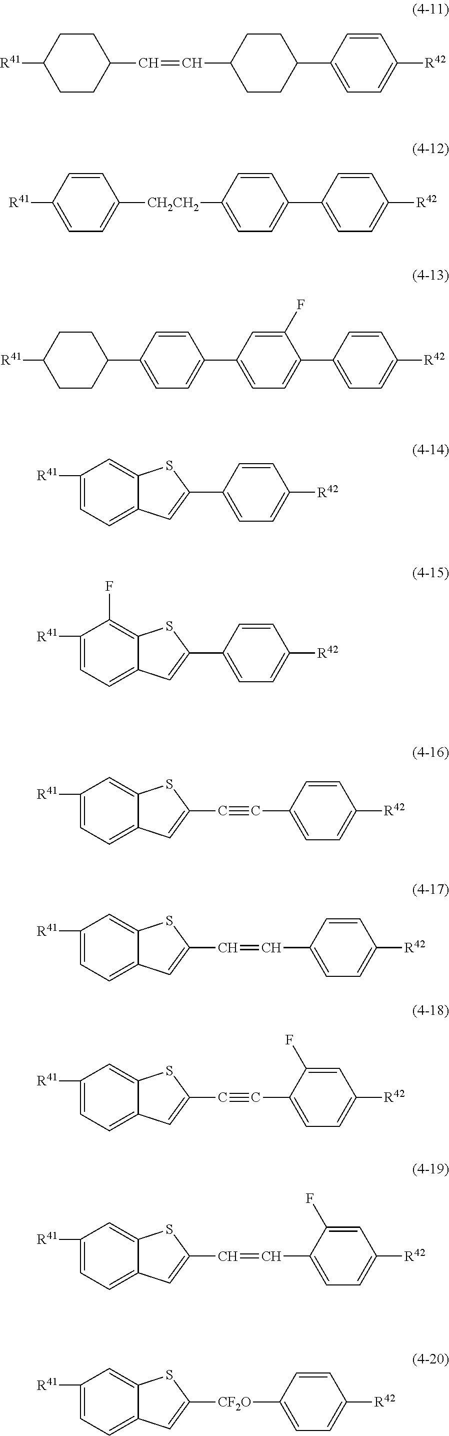

In the above compounds, at least one of Compounds (4) is preferably Compound (4-2), Compound (4-3), Compound (4-8), Compound (4-9), or Compound (4-13). At least two of Compounds (4) are preferably combinations of Compound (4-3) and Compound (4-8), Compound (4-3) and Compound (4-9), or Compound (4-3) and Compound (4-13).

Sixth, additives that may be added to the compositions will be described. Such additives include an optically active compound, an antioxidant, a UV absorber, a dye, a defoamer, a polymerizable compound, a polymerization initiator, a polymerization inhibitor, and the like. Hereinbelow, a proportion of such an additive mixed in is a proportion thereof based on a weight of a liquid crystal composition (weight) unless particularly specified otherwise.

An optically active compound is added to the compositions for the purpose of inducing a helical structure of a liquid crystal to give a twist angle. Examples of such a compound include Compound (5-1) to Compound (5-5). A preferable proportion of the optically active compound is about 5% by weight or lower. A more preferable proportion thereof is in a range of about 0.01% by weight to about 2% by weight.

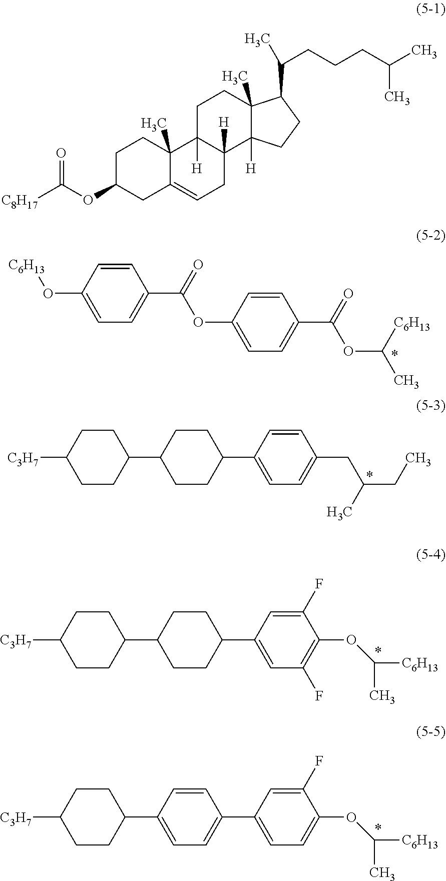

An antioxidant is added to the compositions to prevent a decrease in specific resistance caused by heat in the air or to maintain a high voltage holding ratio not only at room temperature but also at a temperature close to the maximum temperature. A preferable example of the antioxidant is Compound (6) in which t is an integer of 1 to 9 or the like.

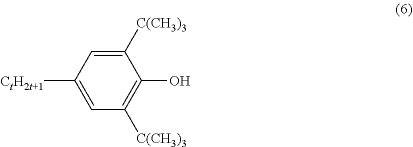

In Compound (6), t is preferably 1, 3, 5, 7, or 9. t is more preferably 7. Since Compound (6) in which t is 7 has low volatility, it is effective for maintaining a voltage holding ratio not only at room temperature but also at a temperature close to the maximum temperature after a device is used for a long period of time. A preferable proportion of the antioxidant is about 50 ppm or higher for obtaining the effect and about 600 ppm or lower not to lower the maximum temperature or raise the minimum temperature. A more preferable proportion thereof is in a range of about 100 ppm to about 300 ppm.

Preferable examples of a UV absorber include a benzophenone derivative, a benzoate derivative, a triazole derivative, and the like. A sterically hindered light stabilizer such as an amine is also preferable. A preferable proportion of such an absorbent or a stabilizer is about 50 ppm or higher for obtaining the effect and about 10,000 ppm or lower not to lower the maximum temperature or to raise the minimum temperature. A more preferable proportion thereof is in a range of about 100 ppm to about 10,000 ppm.

A dichroic dye such as an azo-based dye or an anthraquinone-based dye is added to the compositions to make a device compatible with a guest host (GH) mode. A preferable proportion of the dye is in a range of about 0.01% by weight to about 10% by weight. A defoamer such as dimethyl silicone oil or methyl phenyl silicone oil is added to the compositions to prevent bubbling. A preferable proportion of the defoamer is about 1 ppm or higher to obtain the effect and is about 1,000 ppm or lower to prevent a display defect. A more preferable proportion thereof is in a range of about 1 ppm to about 500 ppm.

A polymerizable compound is added to the compositions to allow compatibility with a polymer-stabilized device. Preferable examples of the polymerizable compound include compounds having a polymerizable group such as an acrylate, a methacrylate, a vinyl compound, a vinyl oxy compound, propenyl ether, an epoxy compound (oxirane or oxetane), and vinyl ketone. More preferable examples are derivatives such as an acrylate and a methacrylate. A preferable proportion of the polymerizable compound is about 0.05% by weight or higher for obtaining the effect and about 20% by weight or lower for preventing a display defect. A more preferable proportion thereof is in a range of about 0.1% by weight to about 10% by weight. The polymerizable compounds are polymerized by UV radiation. Polymerization may be performed in the presence of an initiator such as a photopolymerization initiator. Conditions suitable for polymerization, a suitable type of initiator, and a suitable amount thereof are known to persons skilled in the art and disclosed in the literature. For example, as a photopolymerization initiator, Irgacure 651 (registered trademark, manufactured by BASF), Irgacure 184 (registered trademark, manufactured by BASF), or Darocure 1173 (registered trademark, manufactured by BASF) are suitable for radical polymerization. A preferable proportion of the photopolymerization initiator is in a range of about 0.1 parts by weight to about 5 parts by weight based on 100 parts by weight of the weight of a polymerizable compound. A more preferable proportion thereof is in a range of about 1 part by weight to 3 parts by weight.

When a polymerizable compound is to be stored, a polymerization inhibitor may be added to prevent polymerization. A polymerizable compound is normally added to a composition without removing a polymerization inhibitor. Examples of the polymerization inhibitor include hydroquinone, a hydroquinone derivative such as methyl hydroquinone, 4-tert-butyl catechol, 4-methoxy phenol, phenothiazine, and the like.

Finally, applications of the compositions will be described. The compositions of the present disclosure mainly have the minimum temperature equal to or lower than about −10° C., the maximum temperature equal to or higher than about 70° C., and optical anisotropy in a range of about 0.18 to 0.35. By controlling the proportions of the component compounds or mixing in another liquid crystalline compound, a composition having optical anisotropy in a range of about 0.10 to about 0.18 and further a composition having optical anisotropy in a range of about 0.35 to about 0.40 may be manufactured. The compositions can be used as compositions having a nematic phase or as optically active compositions by adding an optically active compound thereto.

The compositions are applicable to devices used for phase control of electromagnetic wave signals with a frequency of 1 MHz to 400 THz. Application examples include, for example, millimeter wave band variable phase shifters, light detection and ranging (LiDAR) devices, and the like.

In a mode in which optical change due to the Kerr effect is used, a composition having a larger product of optical anisotropy and dielectric anisotropy is desirable, and thus a composition preferably has as large an optical anisotropy as possible. The optical anisotropy is preferably in a range of 0.18 to 0.35 and more preferably in a range of 0.20 to 0.32.

A large dielectric anisotropy of a composition for reducing a drive voltage of a device is desirable. In particular, in a mode in which an electric field applied to a liquid crystal composition is limited by polymer stabilization, encapsulation, or the like, a drive voltage tends to increase, and thus a composition preferably has as large a dielectric anisotropy as possible. In addition, in the mode in which optical change due to the Kerr effect is used, a composition having a large product of optical anisotropy and dielectric anisotropy is desirable, and thus a composition preferably has as large a dielectric anisotropy as possible. A value of the dielectric anisotropy is preferably in a range of 3 to 40 and more preferably in a range of 3 to 20.

### EXAMPLES

The present disclosure will be described in detail using examples. The present disclosure is not limited by the examples. The present disclosure also includes a mixture in which at least two compositions of examples are mixed. Synthesized compounds were identified using a method such as NMR analysis. Characteristics of compounds and compositions were measured using the methods described below.

NMR analysis: a DRX-500 manufactured by Bruker BioSpin was used for measurement. In measurement of ¹H-NMR, a sample was dissolved in a deuterated solvent such as CDCl₃, and measurement was performed under conditions of 500 MHz and a total of 16 times at room temperature. Tetramethylsilane was used as an internal standard. In measurement of ¹⁹F-NMR, CFCl₃ was used as an internal standard a total of 24 times. In description of a nuclear magnetic resonance spectrum, s indicates singlet, d indicates doublet, t indicates triplet, q indicates quartet, quin indicates quintet, sex indicates sextet, m indicates multiplet, and br indicates broad.

Gas chromatography analysis: A GC-14B-type gas chromatography instrument manufactured by Shimadzu Corporation was used for measurement. A carrier gas was helium (2 mL/minute). A sample vaporization chamber was set at 280° C. and a detector (FID) was set at 300° C. A capillary column DB-1 manufactured by Agilent Technologies Inc. (having a length of 30 m, an inner diameter of 0.32 mm, a thickness of 0.25 μm; a stationary liquid phase of dimethylpolysiloxane; non-polar) was used for separation of component compounds. The column was kept at 200° C. for 2 minutes and the temperature was raised to 280° C. at a rate of 5° C. per minute. After the sample was prepared in an acetone solution (0.1% by weight), 1 μL of the solution was injected into a sample vaporization chamber. A recorder was a C-RSA-type Chromatopac manufactured by Shimadzu Corporation or an equivalent thereto. The obtained gas chromatogram showed a peak retention time and a peak area corresponding to the component compounds.

For a solvent for diluting the sample, chloroform, hexane, or the like may be used. For separation of the component compounds, the following capillary columns may be used: HP-1 manufactured by Agilent Technologies Inc. (having a length of 30 m, an inner diameter of 0.32 mm, and a thickness of 0.25 μm), Rtx-1 manufactured by Restek Corporation (having a length of 30 m, an inner diameter of 0.32 mm, and a thickness of 0.25 μm), and BP-1 manufactured by SGE International Pty. Ltd. (having a length of 30 m, an inner diameter of 0.32 mm, and a thickness of 0.25 μm). For the purpose of preventing overlapping of peaks of the compounds, capillary columns CBP1-M50-025 manufactured by Shimadzu Corporation (having a length of 50 m, an inner diameter of 0.25 mm, and a thickness of 0.25 μm) may be used.

A proportion of a liquid crystalline compound included in a composition may be calculated using the following method. A mixture of a liquid crystalline compound is detected by a gas chromatograph (FID). A peak area ratio in a gas chromatogram corresponds to a proportion of the liquid crystalline compound (weight ratio). When the above-described capillary columns are used, a correction factor for each liquid crystalline compound may be regarded as 1. Thus, a proportion of the liquid crystalline compound (% by weight) can be calculated from the peak area ratio.

Measurement sample: When characteristics of compositions were measured, the compositions were used as samples without change. When characteristics of a compound were measured, a sample for measurement was prepared by mixing the compound (15% by weight) with a mother liquid crystal (85% by weight). A characteristic value of a compound was calculated using extrapolation from a value obtained by measurement. (Extrapolated value)={(Measured value of sample)−0.85×(Measured value of mother liquid crystal)}/0.15. When a smectic phase (or crystal) was precipitated at 25° C. at these proportions, the proportions of the compound to the mother liquid crystal were changed to 10% by weight:90% by weight, 5% by weight:95% by weight, and 1% by weight:99% by weight in this order. Values of the maximum temperature, optical anisotropy, viscosity, and dielectric anisotropy of the compound were obtained using extrapolation.

A mother liquid crystal was used as follows. The unit of a proportion of a component compound is % by weight.

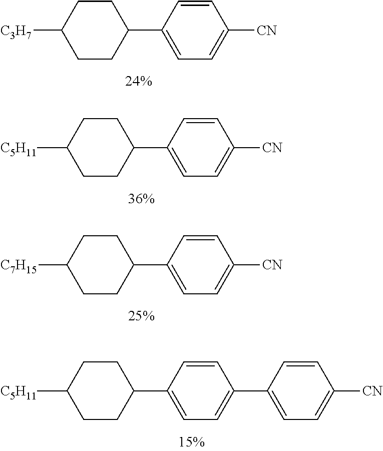

Measurement method: Characteristics were measured using the following methods. Most methods were methods described in Japan Electronics and Information Technology Industries Association (referred to as JEITA below) Standards (JEITA·ED-2521B) reviewed and enacted by JEITA or modified methods thereof. A thin film transistor (TFT) was not installed in a TN device used for the measurement.

Maximum temperature of nematic phase (NI; ° C.): A sample was placed on a hot plate of a melting point measuring apparatus equipped with a polarization microscope and was heated at a rate of 1° C./minute. The temperature when a part of the sample changed to an isotropic liquid from the nematic phase was measured.

Minimum temperature of nematic phase (T_{c}; ° C.): A sample having a nematic phase was put into a glass bottle, the bottle was kept in a freezer for 10 days at temperatures of 0° C., −10° C., −20° C., −30° C., and −40° C., and then the liquid crystal phase was observed. For example, when the sample was in a nematic phase at −20° C. and changed to a crystal or a smectic phase at −30° C., T_{c}<−20° C. was recorded.

Viscosity (bulk viscosity; ii; measured at 20° C.; mPa·s): An E-type rotational viscometer manufactured by Tokyo Keiki Inc. was used for measurement.

Viscosity (rotational viscosity; measured at 20° C.; mPa·s): Measurement was performed in compliance with the method described in Molecular Crystals and Liquid Crystals, Vol. 259, 37 (1995) by M. Imai et al. A sample was put into a TN device having a twist angle of 0° and a gap (cell gap) between two glass substrates of 5 μm. Each voltage of 0.5 V was applied to the device stepwise in a range of 16 V to 19.5 V. After non-application of voltage for 0.2 seconds, application was repeated under the condition of only one square wave (rectangular pulse: 0.2 seconds) and non-application (2 seconds). A peak current and a peak time of the transient current generated due to the application were measured. A value of rotational viscosity was obtained from the measured values and the calculation formula (8) described on page 40 of the paper by M. Imai et al. A value of dielectric anisotropy necessary in the calculation was obtained using the device for the measurement of the rotational viscosity in the following method.

Optical anisotropy (refractive index anisotropy; Δn; measured at 25° C.): Measurement was performed by an Abbe refractometer with a polarizing plate attached to the eyepiece using light with a wavelength of 589 nm. After a surface of a main prism was rubbed in one direction, the sample was dropped on the main prism. A refractive index n∥ was measured when a polarization direction was parallel to the rubbing direction. A refractive index n⊥ was measured when a polarization direction was perpendicular to the rubbing direction. A value of optical anisotropy was calculated from a formula Δn=n∥−n⊥.

Dielectric anisotropy (Δε; measured at 25° C.): A gap (cell gap) between two glass substrates was 9 μm, and a sample was put into a TN device having a twist angle of 80 degrees. A sine wave (10 V and 1 kHz) was applied to the device, and a dielectric constant (ell) in the long axis direction of liquid crystal molecules was measured after 2 seconds. A sine wave (0.5 V and 1 kHz) was applied to the device, and a dielectric constant (ε⊥) in the short axis direction of the liquid crystal molecules was measured after 2 seconds. A value of dielectric anisotropy was calculated from a formula Δε=ε∥−ε⊥.

Threshold voltage (Vth; measured at 25° C.; V): An LCD 5100-type luminance meter manufactured by Otsuka Electronics Co., Ltd. was used for measurement. A light source was a halogen lamp. A gap (cell gap) between two glass substrates was 0.45/Δn (μm), a sample was put into a TN device in a normally white mode having a twist angle of 80 degrees. A voltage (32 Hz and a rectangular wave) applied to the device was increased by 0.02 V stepwise from 0 V to 10 V. At this time, the device was irradiated with light in a perpendicular direction, and the amount of light transmitted through the device was measured. A voltage-transmittance curve indicating that the transmittance was 100% when the amount of light was maximum and the transmittance was 0% when the amount of light was minimum was created. The threshold voltage was represented by the voltage when the transmittance was 90%.

Voltage holding ratio (VHR-1; measured at 25° C.; %): A TN device used for measurement had a polyimide alignment film, and the gap (cell gap) between two glass substrates was 5 μm. After a sample was put into the device, the device was sealed with a UV curable adhesive. A pulse voltage (5 V and 60 microseconds) was applied to the TN device and charged. The attenuating voltage was measured by a high-speed voltmeter for 16.7 milliseconds, and an area A between a voltage curve and the horizontal axis in a unit period was obtained. An area B was an area when the voltage did not attenuate. A voltage holding ratio was indicated by the percentage of the area A with respect to the area B.

Voltage holding ratio (VHR-2; measured at 80° C.; %): A voltage holding ratio was measured in the same process as above at 80° C. instead of 25° C. The obtained value was indicated by VHR-2.

Voltage holding ratio (VHR-3; measured at 25° C.; %): A voltage holding ratio was measured after UV radiation, and UV stability was evaluated. The TN device used for measurement had a polyimide alignment film and a cell gap thereof was 5 μm. A sample was injected into the device and light was radiated for 20 minutes. A light source was an ultra high pressure mercury lamp USH-500D (manufactured by Ushio Inc.), and a distance between the device and the light source was 20 cm. In measurement of VHR-3, an attenuating voltage was measured for 16.7 milliseconds. A composition having large VHR-3 had high UV stability. VHR-3 is preferably 90% or higher and more preferably 95% or higher.

Voltage holding ratio (VHR-4; measured at 25° C.; %): The TN device into which the sample had been injected was heated in a thermostatic chamber at 80° C. for 500 hours, a voltage holding ratio was measured, and thermal stability was evaluated. In measurement of VHR-4, an attenuating voltage was measured for 16.7 milliseconds. A composition having large VHR-4 had high thermal stability.

Response time (τ; measured at 25° C.; ms): An LCD 5100-type luminance meter manufactured by Otsuka Electronics Co., Ltd. was used for measurement. A light source was a halogen lamp. A low-pass filter was set to 5 kHz. The gap (cell gap) between two glass substrates was 5.0 μm, a sample was put into a TN device in a normally white mode having a twist angle of 80 degrees. A rectangular wave (60 Hz, 5 V, 0.5 seconds) was applied to the device. At this time, the device was irradiated with light in a perpendicular direction and the amount of light transmitted through the device was measured. The transmittance was assumed to be 100% when the amount of light was maximum and the transmittance was assumed to be 0% when the amount of light was minimum. A rise time (τr: rise time; millisecond) is a time required for transmittance to charge from 90% to 10%. A fall time (τt: fall time; millisecond) is a time required for transmittance to change from 10% to 90%. A response time is indicated by the sum of the rise time and the fall time obtained as described above.

Elastic constant (K; measured at 25° C.; pN): An HP 4284A-type LCR meter manufactured by Yokogawa-Hewlett Packard Company was used for measurement. A sample was put into a horizontal alignment device having a gap (cell gap) between two glass substrates of 20 μm. Electric charge of 0 to 20 V was applied to the device, and the capacitance and applied voltage were measured. The values of the measured capacitance (C) and applied voltage (V) were fitted using formula (2.98) and formula (2.101) on page 75 of “Liquid Crystal Device Handbook” (Nikkan Kogyo Shimbun), and values of K11 and K33 were obtained from formula (2.99). Next, K22 was calculated using the values of K11 and K33 obtained earlier using formula (3.18) on page 171 of the same document. An elastic constant was indicated by the average value of K11, K22, and K33 obtained as described above.

Specific resistance (ρ; measured at 25° C.; Ωcm): A sample of 1.0 mL was injected into a container having an electrode. A DC voltage (10 V) was applied to the container, and the DC current 10 seconds later was measured. A specific resistance was calculated using the following formula. (Specific resistance)={(voltage)×(capacitance of container)}/{(DC current)×(dielectric constant of vacuum)}.

Helical pitch (P; measured at room temperature; μm): A helical pitch was measured using a wedge method. It is advised to refer to page 196 of “LCD handbook” (published in 2000 by Maruzen). A sample was injected into a wedge-shape cell and left still at room temperature for 2 hours, and an interval of disclination lines (d2-d1) was observed using a polarization microscope (manufactured by Nikkon Corporation; product name MM40/60 series). A helical pitch (P) was calculated using the following formula in which an angle of the wedge cell is indicated by θ. P=2×(d2−d1)×tan θ.

Dielectric constant in short axis direction (ε⊥; measured at 25° C.): A gap between two glass substrates (cell gap) was 9 μm, and a sample was put into a TN device having a twist angle of 80 degrees. A sine wave (0.5 V, 1 kHz) was applied to the device, and a dielectric constant (ε⊥) in the short axis direction of liquid crystal molecules was measured two seconds later.

Optical anisotropy and dielectric loss at 50 GHz (measured at 25° C.): Optical anisotropy at 50 GHz (Δn (at 50 GHz)) was measured using the method disclosed in “Applied Optics” Vol. 44, No. 7, p 1150 (2005). For optical anisotropy, a variable short circuit waveguide of a V band with a window material attached was filled with liquid crystal and held in a static magnetic field of 0.3 T for 3 minutes. A microwave of 50 GHz was input to the waveguide, and an amplitude ratio of a reflected wave with respect to incident wave was measured. A direction of the static magnetic field and a tube length of a short circuiter were changed and measured, and a refractive index (ne and no) and loss parameters (αe and αo) were determined. Optical anisotropy (Δn (at 50 GHz)) was calculated from ne-no.

Tan δ at 50 GHz (at 50 GHz) was calculated using complex dielectric constants (ε′ and ε″) as a dielectric loss (tan δ)=ε″/ε′. For calculation of complex dielectric constants, the refractive index calculated in the previous paragraph, the loss parameters, and the following relational expression were used. Here, c indicates a light speed in vacuum. Since anisotropy is exhibited also in the dielectric loss, a larger value was recorded.

ε′=n²−κ²

ε″=2nκ

α=2ωc/κ

Compounds of examples were represented by symbols based on the definitions of the following Table 2. In Table 2, the numbers in the parenthesis after the symbols correspond to the numbers of the compounds. The symbol (−) means other liquid crystalline compounds. A proportion (percentage) of a liquid crystalline compound is a weight percentage (% by weight) based on a weight of the liquid crystal composition. Finally, characteristic values of compositions are summarized.

TABLE 2
Method for description of compounds using symbols
R—(A₁)—Z₁— . . . —Zₙ—(Aₙ)—R′

| 1) Left-terminal group R— | Symbol |
|---|---|
| CₙH₂ₙ₋₁— | n- |
| CₙH₂ₙ₋₁O— | nO— |
| CₘH₂ₘ₋₁OCₙH₂ₙ— | mOn— |
| CH₂═CH— | V— |
| CₙH₂ₙ₋₁—CH═CH— | nV— |
| CH₂═X=CH—CₙH₂ₙ— | |
| CₘH₂ₘ₋₁—CH═CH—CₙH₂ₙ— | mVn— |
| CF₂═CH— | VFF— |
| CF₂═CH−CₙH₂ₙ— | VFFn— |
| 2) Right-terminal group —R′ | Symbol |
| —CₙH₂ₙ₋₁ | -n |
| —OCₙH₂ₙ₋₁ | —On |
| —CH═CH₂ | —V |
| —CH═CH—CₙH₂ₙ₋₁ | —Vn |
| —CₙH₂ₙ—CH═CH₂ | —nV |
| —CₙH₂ₙ—CH═CH—CₘH₂ₘ₋₁ | —nVm |
| —CH═CF₂ | —VFF |
| −COOCH₃ | —EMe |
| —F | —F |
| —Cl | —CL |
| —OCF₃ | —OCF3 |
| —CF₃ | —CF3 |
| —CN | —C |
| —OCH═CH—CF₂H | —OVCF2H |
| —OCH═CH—CF₃ | —OVCF3 |
| 3) Bonding group —Zₙ— | Symbol |
| —C₂H₄— | 2 |
| —COO— | E |
| —CH═CH— | V |
| —C≡C— | T |
| —CF₂O— | X |
| —CH₂O— | 1O |
| 4) Ring structure —Aₙ— | Symbol |
| 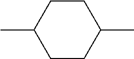 | H |
| 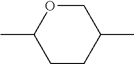 | Dh |
| 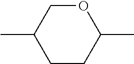 | dh |
| 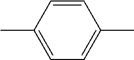 | B |
| 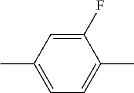 | B(F) |
| 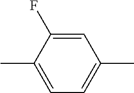 | B(2F) |
| 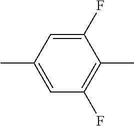 | B(F,F) |
| 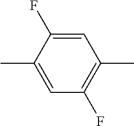 | B(2F,5F) |
| 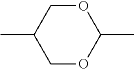 | G |
| 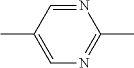 | Py |
| 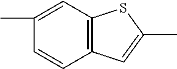 | bt |
| 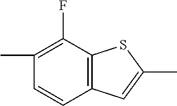 | bt(7F) |

5) Examples of description
Example 1 3-BB(F)TB-2

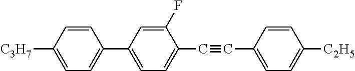

Example 2 4-BB(F)B(F,F)XB(F,F)—F

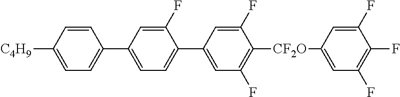

Example 3 3-BB(F)B(F,F)—F

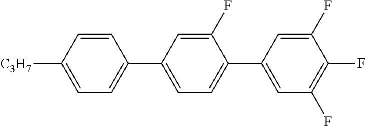

Example 4 2O—bt(7F)B-3

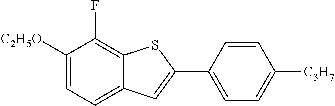

### [Example 1] Liquid Crystal Composition 1

| | | |
|---|---|---|
| 3-HB(F)TB-2 | (1-3) | 5% |
| 3-HB(F)TB-3 | (1-3) | 5% |
| 3-HB(F)TB-4 | (1-3) | 5% |
| 3-H2BTB-2 | (1-5) | 3% |
| 3-H2BTB-3 | (1-5) | 3% |
| 3-H2BTB-4 | (1-5) | 3% |
| 3-BB(F)B(F,F)XB(F)-F | (2-1) | 3% |
| 3-BB(F)B(F,F)XB(F,F)-F | (2-2) | 2% |
| 4-BB(F)B(F,F)XB(F,F)-F | (2-2) | 7% |
| 5-BB(F)B(F,F)XB(F,F)-F | (2-2) | 7% |
| 3-BB(F,F)XB(F)B(F,F)-F | (2-10) | 6% |
| 3-BB(F)B(F,F)-F | (3-4) | 3% |
| 2-BTB-O1 | (4-3) | 7.8% |
| 3-BTB-O1 | (4-3) | 7.8% |
| 4-BTB-O1 | (4-3) | 7.8% |
| 4-BTB-O2 | (4-3) | 7.8% |
| 5-BTB-O1 | (4-3) | 7.8% |
| 3-BB(F,F)XB(F,F)-F | (-) | 9% |

NI=90.0° C.; Tc<−20° C.; Δn=0.246; Δε=9.4; Vth=1.88; η=42.7 mPa·s; γ1=279 mPa·s; ρ=1.3×10¹⁴ Ωcm.
Optical anisotropy and dielectric loss of the liquid crystal composition 1 at 50 GHz were as follows.

Δn (at 50 GHz)=0.16

tan δ (at 50 GHz)=0.013

### [Example 2] Liquid Crystal Composition 2

| | | |
|---|---|---|
| 3-HB(F)TB-2 | (1-3) | 5% |
| 3-HB(F)TB-3 | (1-3) | 5% |
| 3-HB(F)TB-4 | (1-3) | 4% |
| 2-BTB(F)TB-5 | (1-11) | 5% |
| 3-BTB(F)TB-5 | (1-11) | 6% |
| 4-BTB(F)TB-5 | (1-11) | 5% |
| 5-BTB(F)TB-2 | (1-11) | 6% |
| 3-BB(F)B(F,F)XB(F)-F | (2-1) | 3% |
| 3-BB(F)B(F,F)XB(F,F)-F | (2-2) | 2% |
| 4-BB(F)B(F,F)XB(F,F)-F | (2-2) | 9% |
| 5-BB(F)B(F,F)XB(F,F)-F | (2-2) | 9% |
| 3-BB(F,F)XB(F)B(F,F)-F | (2-10) | 7% |
| 3-BB(F)B(F,F)-F | (3-4) | 8% |
| 2-BTB-1 | (4-3) | 15% |
| 1-BTB-3 | (4-3) | 11% |

NI=104.2° C.; Tc<−10° C.; Δn=0.290; Δε=10.0; Vth=2.00; η=37.1 mPa·s; γ1=337 mPa·s; ρ=2.2×10¹³ Ωcm.

### [Example 3] Liquid Crystal Composition 3

| | | |
|---|---|---|
| 3-HB(F)TB-2 | (1-3) | 7% |
| 3-HB(F)TB-3 | (1-3) | 7% |
| 3-HB(F)TB-4 | (1-3) | 7% |
| 3-BB(F)B(F,F)XB(F,F)-F | (2-2) | 2% |
| 4-BB(F)B(F,F)XB(F,F)-F | (2-2) | 8% |
| 5-BB(F)B(F,F)XB(F,F)-F | (2-2) | 8% |
| 4-GB(F)B(F,F)XB(F,F)-F | (2-9) | 5% |
| 2-BTB-O1 | (4-3) | 6.8% |
| 3-BTB-O1 | (4-3) | 6.8% |
| 4-BTB-O1 | (4-3) | 6.8% |
| 4-BTB-O2 | (4-3) | 6.8% |
| 5-BTB-O1 | (4-3) | 6.8% |
| 5-HBB(F)B-2 | (4-13) | 6% |
| 5-HBB(F)B-3 | (4-13) | 5% |
| 3-BB(F,F)XB(F,F)-F | (-) | 11% |

NI=111.6° C.; Tc<−10° C.; Δn=0.243; Δε=10.2; Vth=2.18; η=63.7 mPa·s; γ1=343 mPa·s; ρ=3.6×10¹³ Ωcm.

### [Example 4] Liquid Crystal Composition 4

| | | |
|---|---|---|
| 3-HB(F)TB-2 | (1-3) | 5% |
| 3-HB(F)TB-3 | (1-3) | 3% |
| 3-BB(F)TB-2 | (1-4) | 8% |
| 3-BB(F)TB-3 | (1-4) | 8% |
| 3-BB(F)TB-4 | (1-4) | 8% |
| 3-BB(F)B(F,F)XB(F)-F | (2-1) | 3% |
| 3-BB(F)B(F,F)XB(F,F)-F | (2-2) | 2% |
| 4-BB(F)B(F,F)XB(F,F)-F | (2-2) | 8% |
| 5-BB(F)B(F,F)XB(F,F)-F | (2-2) | 8% |
| 3-BB(F,F)XB(F)B(F,F)-F | (2-10) | 6% |
| 2O-bt(7F)B-2 | (4-15) | 6.2% |
| 1O-bt(7F)B-3 | (4-15) | 6.2% |
| 2O-bt(7F)B-3 | (4-15) | 6.2% |
| 2O-bt(7F)B-4 | (4-15) | 6.2% |
| 2O-bt(7F)B-5 | (4-15) | 6.2% |
| 3-BB(F,F)XB(F,F)-F | (-) | 10% |

### NI=118.1° C.; Tc<−10° C.; Δη=0.275; Δε=13.4.

### [Example 5] Liquid Crystal Composition 5

| | | |
|---|---|---|
| 3-HB(F)TB-2 | (1-3) | 8% |
| 3-HB(F)TB-3 | (1-3) | 8% |
| 3-HB(F)TB-4 | (1-3) | 7% |
| 3-H2BTB-2 | (1-5) | 5% |
| 3-H2BTB-3 | (1-5) | 5% |
| 3-H2BTB-4 | (1-5) | 5% |
| 3-BB(F)B(F,F)XB(F,F)-F | (2-2) | 2% |
| 4-BB(F)B(F,F)XB(F,F)-F | (2-2) | 8% |
| 5-BB(F)B(F,F)XB(F,F)-F | (2-2) | 8% |
| 4-GB(F)B(F,F)XB(F,F)-F | (2-9) | 5% |
| 5-GB(F)B(F,F)XB(F,F)-F | (2-9) | 4% |
| 3-BB(F,F)XB(F)B(F,F)-F | (2-10) | 9% |
| 2-BTB-O1 | (4-3) | 5.2% |
| 3-BTB-O1 | (4-3) | 5.2% |
| 4-BTB-O1 | (4-3) | 5.2% |
| 4-BTB-O2 | (4-3) | 5.2% |
| 5-BTB-O1 | (4-3) | 5.2% |

NI=118.5° C.; Tc<−10° C.; Δη=0.247; Δε=12.0; Vth=2.02; η=70.0 mPa·s; γ1=429 mPa·s; ρ=5.2×10¹³ Ωcm.

### [Example 6] Liquid Crystal Composition 6

| | | |
|---|---|---|
| 3-HB(F)TB-2 | (1-3) | 5% |
| 3-HB(F)TB-3 | (1-3) | 5% |
| 3-HB(F)TB-4 | (1-3) | 5% |
| 3-BB(F)TB-2 | (1-4) | 4% |
| 3-BB(F)TB-3 | (1-4) | 4% |
| 3-BB(F)TB-4 | (1-4) | 4% |
| 3-BB(F)B(F,F)XB(F,F)-F | (2-2) | 2% |
| 4-BB(F)B(F,F)XB(F,F)-F | (2-2) | 8% |
| 5-BB(F)B(F,F)XB(F,F)-F | (2-2) | 6% |
| 4-GB(F)B(F,F)XB(F,F)-F | (2-9) | 4% |
| 5-GB(F)B(F,F)XB(F,F)-F | (2-9) | 4% |
| 3-BB(F,F)XB(F)B(F,F)-F | (2-10) | 6% |
| 2-BTB-O1 | (4-3) | 4.8% |
| 3-BTB-O1 | (4-3) | 4.8% |
| 4-BTB-O1 | (4-3) | 4.8% |
| 4-BTB-O2 | (4-3) | 4.8% |
| 5-BTB-O1 | (4-3) | 4.8% |
| 3-GB(F,F)XB(F,F)-F | (-) | 6% |
| 3-BB(F,F)XB(F,F)-F | (-) | 13% |

NI=91.8° C.; Tc<−10° C.; Δη=0.240; Δε=17.5; Vth=1.45; γ1=349 mPa·s; ρ=2.3×10¹³ Ωcm.

### [Example 7] Liquid Crystal Composition 7

| | | |
|---|---|---|
| 3-HB(F)TB-2 | (1-3) | 5% |
| 3-HB(F)TB-3 | (1-3) | 4% |
| 3-BB(F)TB-2 | (1-4) | 7% |
| 3-BB(F)TB-3 | (1-4) | 7% |
| 3-BB(F)TB-4 | (1-4) | 7% |
| 3-BB(F)B(F,F)XB(F,F)-F | (2-2) | 2% |
| 4-BB(F)B(F,F)XB(F,F)-F | (2-2) | 10% |
| 5-BB(F)B(F,F)XB(F,F)-F | (2-2) | 6% |
| 4-BTB(F)B(F,F)XB(F,F)-F | (2-6) | 6% |
| 5-BTB(F)B(F,F)XB(F,F)-F | (2-6) | 6% |
| 3-BB(F,F)XB(F)B(F,F)-F | (2-10) | 6% |
| 2-BTB-O1 | (4-3) | 6.8% |
| 3-BTB-O1 | (4-3) | 6.8% |
| 4-BTB-O1 | (4-3) | 6.8% |
| 4-BTB-O2 | (4-3) | 6.8% |
| 5-BTB-O1 | (4-3) | 6.8% |

NI=113.3° C.; Tc<−10° C.; Δη=0.292; Δε=11.1; Vth=2.01; γ1=405 mPa·s; ρ=3.3×10¹³ Ωcm.

### [Example 8] Liquid Crystal Composition 8

| | | |
|---|---|---|
| 3-HB(F)TB-2 | (1-3) | 6% |
| 3-HB(F)TB-3 | (1-3) | 5% |
| 3-HB(F)TB-4 | (1-3) | 5% |
| 3-H2BTB-2 | (1-5) | 4% |
| 3-BB(F)B(F,F)XB(F,F)-F | (2-2) | 2% |
| 4-BB(F)B(F,F)XB(F,F)-F | (2-2) | 9% |
| 5-BB(F)B(F,F)XB(F,F)-F | (2-2) | 6% |
| 2-BTB-O1 | (4-3) | 10% |
| 3-BTB-O1 | (4-3) | 10% |
| 4-BTB-O1 | (4-3) | 10% |
| 4-BTB-O2 | (4-3) | 10% |
| 5-BTB-O1 | (4-3) | 10% |
| 3-HHB-1 | (4-5) | 4% |
| 3-HHB-3 | (4-5) | 5% |
| 3-BB(F,F)XB(F,F)-F | (-) | 4% |

NI=93.0° C.; Tc<−20° C.; Δη=0.244; Δε=4.7; Vth=2.42; γ1=229 mPa·s; ρ=1.3×10¹⁴ Ωcm.

### [Example 9] Liquid Crystal Composition 9

| | | |
|---|---|---|
| 3-HB(F)TB-2 | (1-3) | 7% |
| 3-HB(F)TB-3 | (1-3) | 6% |
| 3-HB(F)TB-4 | (1-3) | 6% |
| 3-H2BTB-2 | (1-5) | 2% |
| 3-H2BTB-3 | (1-5) | 2% |
| 3-BB(F,F)XB(F)B(F,F)-F | (2-10) | 10% |
| 3-BB(F)B(F,F)-F | (3-4) | 9% |
| 2-BTB-O1 | (4-3) | 7% |
| 3-BTB-O1 | (4-3) | 7% |
| 4-BTB-O1 | (4-3) | 7% |
| 4-BTB-O2 | (4-3) | 7% |
| 5-BTB-O1 | (4-3) | 6% |
| 1-BB(F)B-2V | (4-9) | 6% |
| 2-BB(F)B-2V | (4-9) | 6% |
| 3-BB(F)B-2V | (4-9) | 7% |
| 3-BB(F,F)XB(F,F)-F | (-) | 5% |

NI=100.6° C.; Tc<−30° C.; Δη=0.258; Δε=5.1; η=36.4 mPa·s

### [Example 10] Liquid Crystal Composition 10

| | | |
|---|---|---|
| 3-HB(F)TB-2 | (1-3) | 7% |
| 3-HB(F)TB-3 | (1-3) | 6% |
| 3-HB(F)TB-4 | (1-3) | 6% |
| 3-H2BTB-2 | (1-5) | 4% |
| 3-H2BTB-3 | (1-5) | 3% |
| 3-H2BTB-4 | (1-5) | 2% |
| 3-BB(F,F)XB(F)B(F,F)-F | (2-10) | 12% |
| 3-GBB(F)B(F,F)-F | (3-9) | 6% |
| 4-GBB(F)B(F,F)-F | (3-9) | 6% |
| 3-GB(F)B(F)B(F)-F | (3-11) | 8% |
| 2-BTB-O1 | (4-3) | 8% |
| 3-BTB-O1 | (4-3) | 8% |
| 4-BTB-O1 | (4-3) | 8% |
| 4-BTB-O2 | (4-3) | 8% |
| 5-BTB-O1 | (4-3) | 7% |
| 3-BB(F,F)XB(F,F)-F | (-) | 1% |

NI=118.8° C.; Tc<−30° C.; Δη=0.259; Δε=8.2; η=54.7 mPa·s

### [Example 11] Liquid Crystal Composition 11

| | | |
|---|---|---|
| 3-HB(F)TB-2 | (1-3) | 9% |
| 3-HB(F)TB-3 | (1-3) | 8% |
| 3-HB(F)TB-4 | (1-3) | 8% |
| 3-H2BTB-2 | (1-5) | 4% |
| 3-H2BTB-3 | (1-5) | 3% |
| 3-H2BTB-4 | (1-5) | 2% |
| 3-BB(F,F)XB(F)B(F,F)-F | (2-10) | 12% |
| 3-BB(F)B(F,F)-F | (3-4) | 14% |
| 2-BTB-O1 | (4-3) | 8% |
| 3-BTB-O1 | (4-3) | 8% |
| 4-BTB-O1 | (4-3) | 8% |
| 4-BTB-O2 | (4-3) | 8% |
| 5-BTB-O1 | (4-3) | 7% |
| 3-BB(F,F)XB(F,F)-F | (-) | 1% |

NI=99.3° C.; Tc<−20° C.; Δη=0.255; Δε=5.5; η=36.4 mPa·s

### [Example 12] Liquid Crystal Composition 12

| | | |
|---|---|---|
| 3-HB(F)TB-2 | (1-3) | 6% |
| 3-HB(F)TB-3 | (1-3) | 6% |
| 3-HB(F)TB-4 | (1-3) | 5% |
| 3-H2BTB-2 | (1-5) | 2% |
| 3-H2BTB-3 | (1-5) | 2% |
| 3-H2BTB-4 | (1-5) | 2% |
| 3-BB(F,F)XB(F)B(F,F)-F | (2-10) | 12% |
| 3-GBB(F)B(F,F)-F | (3-9) | 1% |
| 4-GBB(F)B(F,F)-F | (3-9) | 1% |
| 3-GB(F)B(F)B(F)-F | (3-11) | 4% |
| 2-BTB-O1 | (4-3) | 7% |
| 3-BTB-O1 | (4-3) | 7% |
| 4-BTB-O1 | (4-3) | 7% |
| 4-BTB-O2 | (4-3) | 7% |
| 5-BTB-O1 | (4-3) | 6% |
| 1-BB(F)B-2V | (4-9) | 4% |
| 2-BB(F)B-2V | (4-9) | 4% |
| 3-BB(F)B-2V | (4-9) | 4% |
| 2-BB(F)B-3 | (4-9) | 4% |
| 2-BB(F)B-5 | (4-9) | 4% |
| 3-BB(F)B-5 | (4-9) | 4% |
| 3-BB(F,F)XB(F,F)-F | (-) | 1% |

NI=113.4° C.; Tc<−20° C.; Δη=0.265; Δε=4.3; η=39.5 mPa·s

### [Example 13] Liquid Crystal Composition 13

| | | |
|---|---|---|
| 3-HB(F)TB-2 | (1-3) | 7% |
| 3-HB(F)TB-3 | (1-3) | 6% |
| 3-HB(F)TB-4 | (1-3) | 6% |
| 3-BB(F)TB-2 | (1-4) | 6% |
| 3-BB(F)TB-3 | (1-4) | 6% |
| 3-BB(F)TB-4 | (1-4) | 7% |
| 3-H2BTB-2 | (1-5) | 3% |
| 3-H2BTB-3 | (1-5) | 3% |
| 3-H2BTB-4 | (1-5) | 3% |
| 3-BB(F,F)XB(F)B(F,F)-F | (2-10) | 10% |
| 2-BTB-O1 | (4-3) | 7% |
| 3-BTB-O1 | (4-3) | 7% |
| 4-BTB-O1 | (4-3) | 7% |
| 4-BTB-O2 | (4-3) | 7% |
| 5-BTB-O1 | (4-3) | 6% |
| 3-BB(F,F)XB(F,F)-F | (-) | 9% |

### NI=110.7° C.; Tc<−20° C.; Δη=0.279; Δε=4.3

### INDUSTRIAL APPLICABILITY

A liquid crystal composition of the present disclosure satisfies at least one characteristic or has good balance between at least two characteristics among characteristics including a high maximum temperature, a low minimum temperature, large optical anisotropy, large positive dielectric anisotropy, and the like. A device containing the composition can be used for phase control of electromagnetic wave signals with a frequency of 1 MHz to 400 THz.

What is claimed is:

1. A liquid crystal composition containing at least one compound represented by formula (1) and at least one compound represented by formula (2) and is used for phase control of an electromagnetic wave signal with any frequency of 1 MHz to 400 THz, 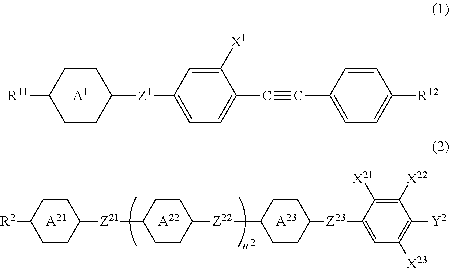
wherein, in formula (1) and formula (2), R¹¹, R¹² and R² are each independently alkyl having one to twelve carbon atoms, alkoxy having one to twelve carbon atoms, alkenyl having two to twelve carbon atoms, or alkoxyalkyl having two to twelve carbon atoms; rings A¹, A²¹, A²² and A²³ are each independently 1,4-cyclohexylene, 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl, or tetrahydropyran-2,5-diyl; Z¹, Z²¹, Z²² and Z²³ are each independently a single bond, ethylene, vinylene, methyleneoxy, carbonyloxy, difluoromethyleneoxy, ethynylene, or tetrafluoroethylene, wherein at least one of Z²¹, Z²² and Z²³ is difluoromethyleneoxy; X¹, X²¹, X²² and X²³ are each independently hydrogen or fluorine, wherein X²¹ and X²² are not fluorine at the same time; Y² is fluorine, chlorine, alkyl having one to twelve carbon atoms in which at least one hydrogen atom may be replaced by a halogen, alkoxy having one to twelve carbon atoms in which at least one hydrogen atom may be replaced by a halogen, or alkenyl having two to twelve carbon atoms in which at least one hydrogen atom may be replaced by a halogen; and n² is 1 or 2, and in a case in which n² is 2, plural rings A²² and Z²² may be the same or different.

2. The liquid crystal composition according to claim 1, containing at least one compound selected from a group consisting of compounds represented by formula (1-1) to formula (1-13), 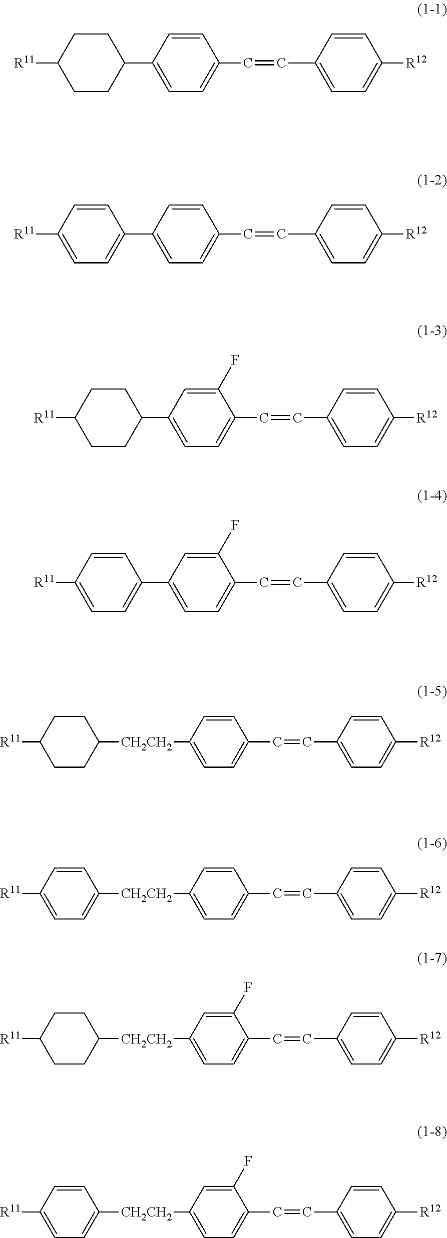 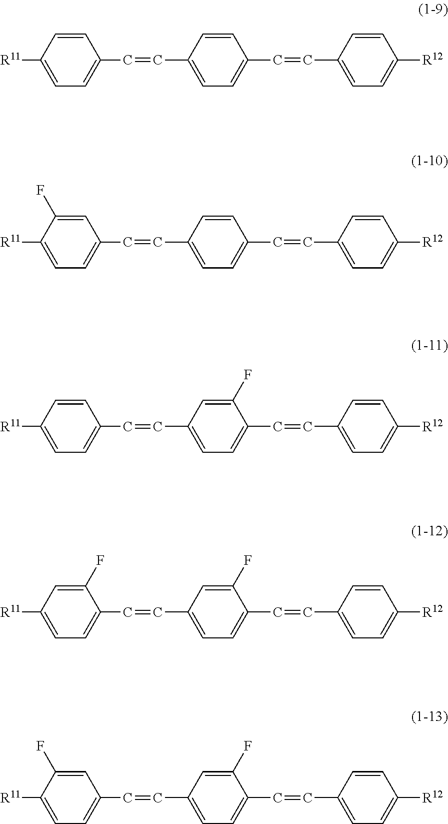
wherein, in the formulas, R¹¹ and R¹² are each independently alkyl having one to twelve carbon atoms, alkoxy having one to twelve carbon atoms, or alkenyl having two to twelve carbon atoms.

3. The liquid crystal composition according to claim 1, wherein a proportion of the compound represented by formula (1) according to claim 1 is in a range of 10% by weight to 70% by weight based on a weight of the liquid crystal composition.

4. The liquid crystal composition according to claim 1, containing at least one compound selected from a group consisting of compounds represented by formula (2-1) to formula (2-15): 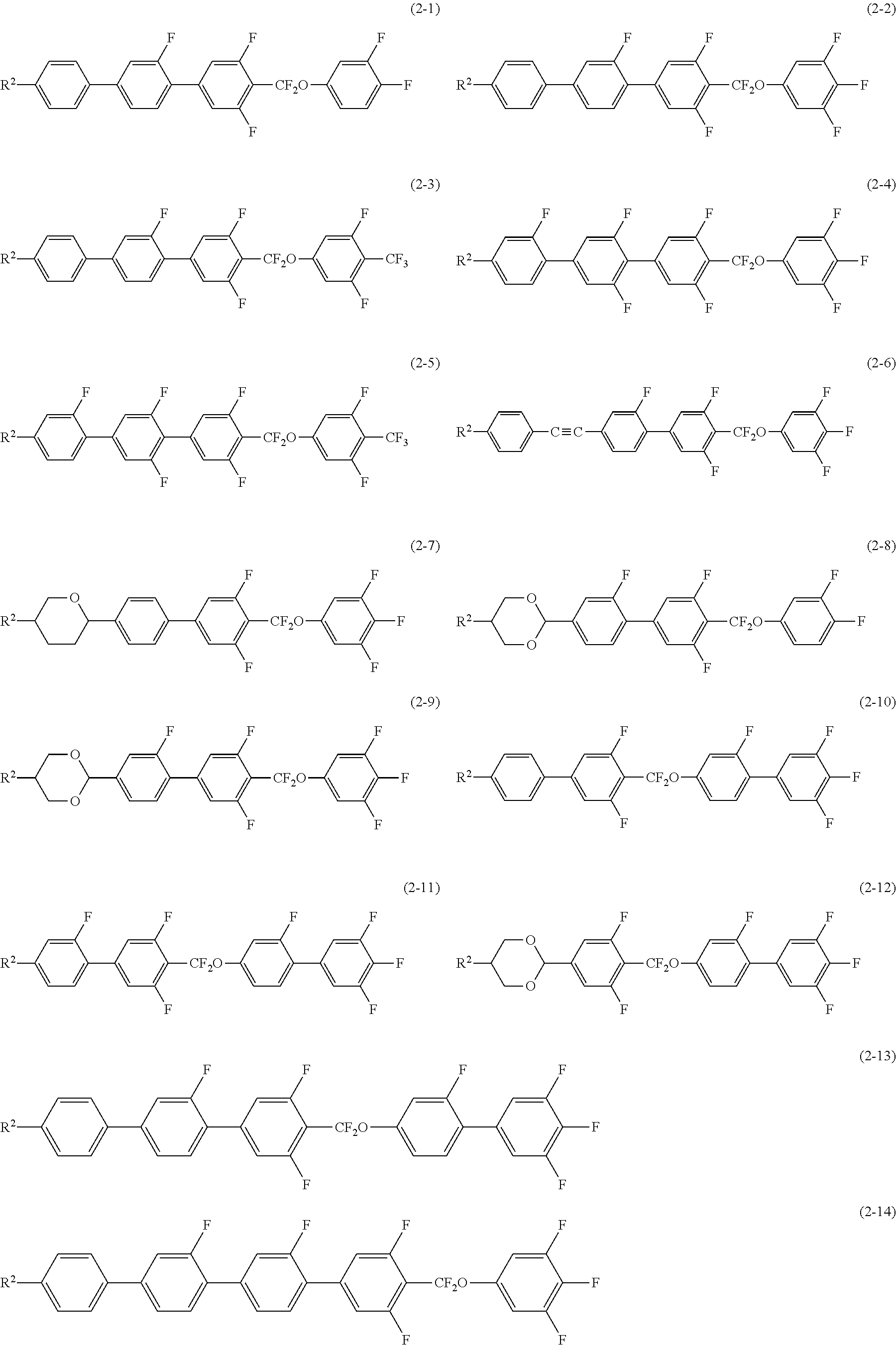 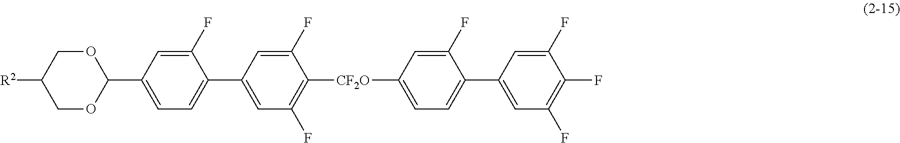
wherein, in the formulas, R² is alkyl having one to twelve carbon atoms, alkoxy having one to twelve carbon atoms, alkenyl having two to twelve carbon atoms, or alkoxyalkyl having a total of two to twelve carbon atoms.

5. The liquid crystal composition according to claim 1, wherein a proportion of the compound represented by formula (2) according to claim 1 is in a range of 5% by weight to 55% by weight based on a weight of the liquid crystal composition.

6. The liquid crystal composition according to claim 1, further containing at least one compound represented by formula (3): 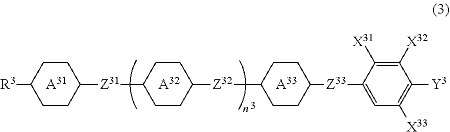
wherein, in formula (3), R³ is alkyl having one to twelve carbon atoms, alkoxy having one to twelve carbon atoms, or alkenyl having two to twelve carbon atoms; ring A³¹, ring A³², and ring A³³ are each independently 1,4-phenylene, 2-fluoro-1,4-phenylene, 2,5-difluoro-1,4-phenylene, 2,6-difluoro-1,4-phenylene, pyridine-2,5-diyl, pyrimidine-2,5-diyl, 1,3-dioxane-2,5-diyl, or tetrahydropyran-2,5-diyl; Z³¹, Z³², and Z³³ are each independently a single bond, ethylene, vinylene, methyleneoxy, carbonyloxy, ethynylene, or tetrafluoroethylene; X³¹, X³², and X³³ are each independently hydrogen or fluorine, wherein X³¹ and X³² are not fluorine at the same time; Y³ is fluorine, chlorine, alkyl having one to twelve carbon atoms in which at least one hydrogen atom may be replaced by a halogen, alkoxy having one to twelve carbon atoms in which at least one hydrogen atom may be replaced by a halogen, or alkenyl having two to twelve carbon atoms in which at least one hydrogen atom may be replaced by a halogen; and n³ is 0, 1, or 2, and in a case in which n³ is 2, plural rings A³² and Z³² may be the same or different.

7. The liquid crystal composition according to claim 6, containing at least one compound selected from a group consisting of compounds represented by formula (3-1) to formula (3-12): 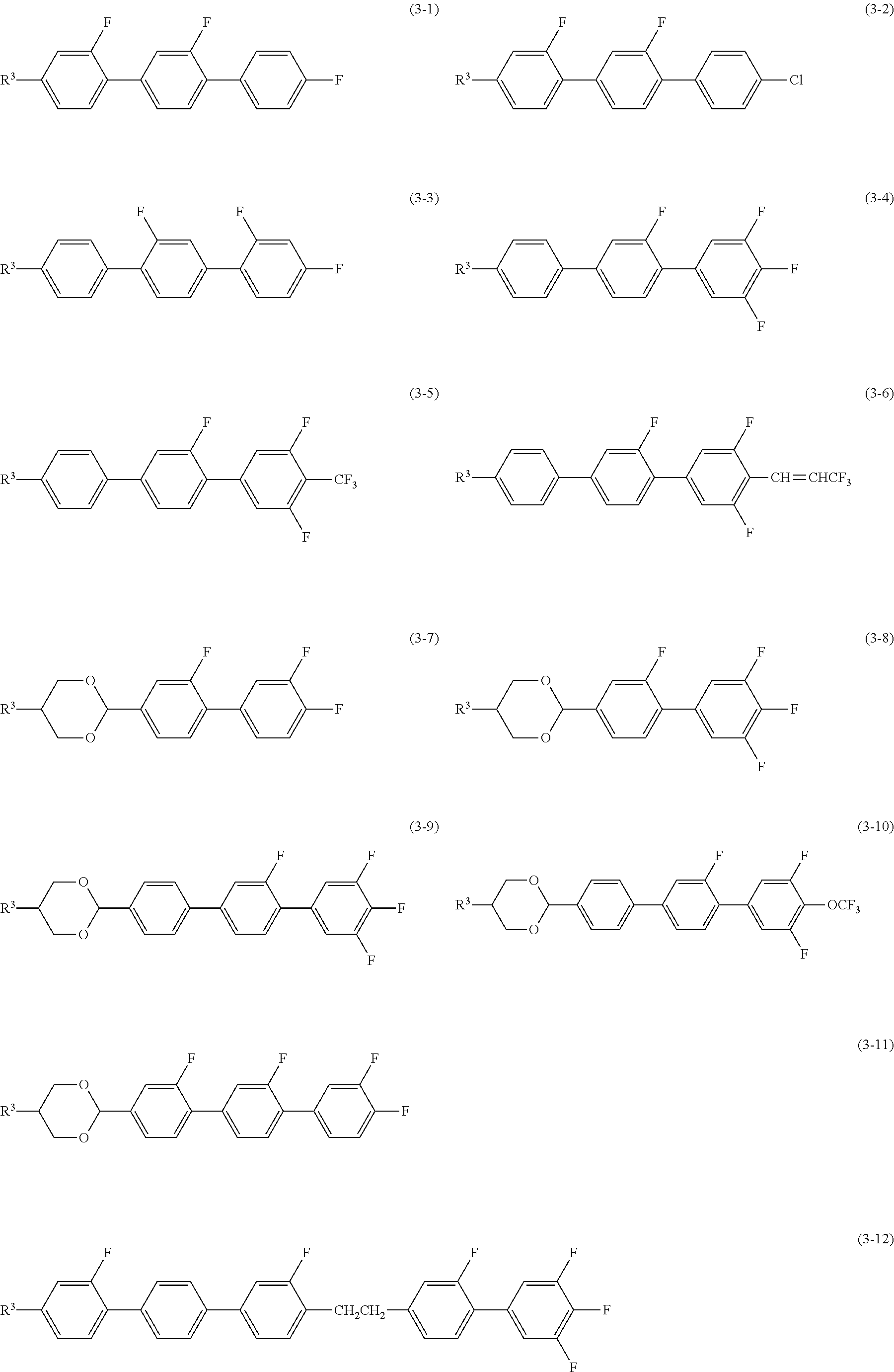
wherein, in the formulas, R³ is alkyl having one to twelve carbon atoms, alkoxy having one to twelve carbon atoms, or alkenyl having two to twelve carbon atoms.

8. The liquid crystal composition according to claim 6, wherein a proportion of the compound represented by formula (3) is in a range of 3% by weight to 40% by weight based on a weight of the liquid crystal composition.

9. The liquid crystal composition according to claim 1, further containing at least one compound represented by formula (4): 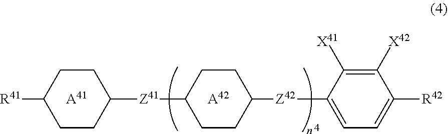
wherein, in formula (4), R⁴¹ and R⁴² are each independently alkyl having one to twelve carbon atoms, alkoxy having one to twelve carbon atoms, or alkenyl having two to twelve carbon atoms; ring A⁴¹ and ring A⁴² are each independently 1,4-cyclohexylene, 1,4-phenylene, 2-fluoro-1,4-phenylene, 2,5-difluoro-1,4-phenylene, 2,6-difluoro-1,4-phenylene, or 2,6-benzothiophene; Z⁴¹ is a single bond, ethylene, vinylene, methyleneoxy, carbonyloxy, difluoromethyleneoxy, ethynylene, or tetrafluoroethylene; Z⁴² is a single bond, ethylene, vinylene, methyleneoxy, carbonyloxy, difluoromethyleneoxy, or tetrafluoroethylene; X⁴¹ and X⁴² are each independently hydrogen or fluorine, wherein X⁴¹ and X⁴² are not fluorine at the same time; and n⁴ is 0, 1, or 2, in a case in which n⁴ is 1 or 2, Z⁴¹ is not ethynylene, and in a case in which n⁴ is 2, plural rings A⁴² and Z⁴² may be the same or different.

10. The liquid crystal composition according to claim 9, containing at least one compound selected from a group consisting of compounds represented by formula (4-1) to formula (4-20): 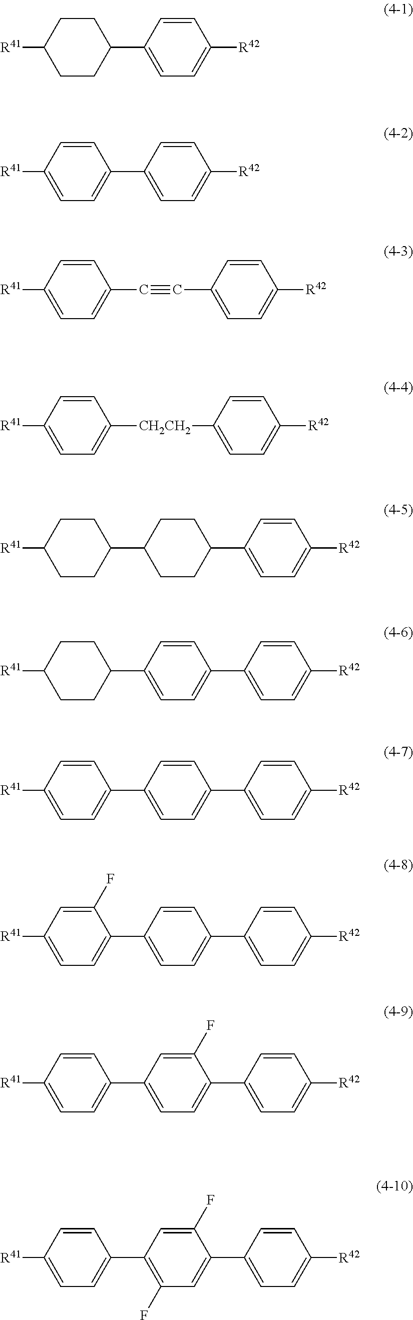 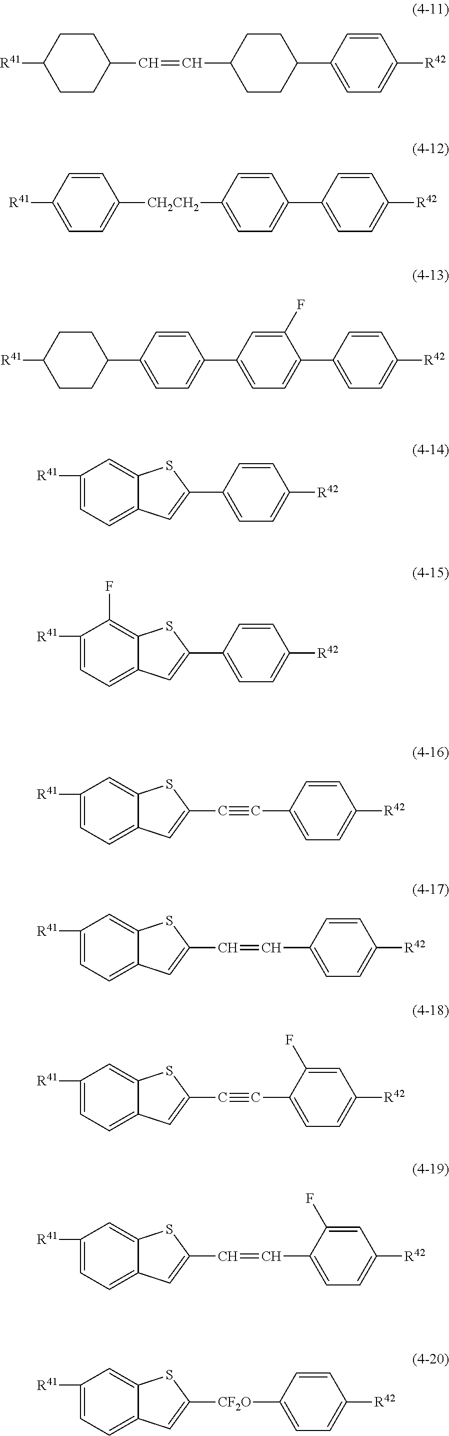
wherein, in the formulas, R⁴¹ and R⁴² are each independently alkyl having one to twelve carbon atoms, alkoxy having one to twelve carbon atoms, or alkenyl having two to twelve carbon atoms.

11. The liquid crystal composition according to claim 9, wherein a proportion of the compound represented by formula (4) is in a range of 10% by weight to 70% by weight based on a weight of the liquid crystal composition.

12. The liquid crystal composition according to claim 1, wherein an optical anisotropy at a wavelength of 589 nm and a temperature of 25° C. is in a range of 0.18 to 0.35, and a dielectric anisotropy at a frequency of 1 kHz and a temperature of 25° C. is in a range of 3 to 40.

13. The liquid crystal composition according to claim 1, wherein an optical anisotropy at any frequency of 1 GHz to 50 GHz and a temperature of 25° C. is in a range of 0.10 to 0.40.

14. The liquid crystal composition according to claim 1, comprising an optically active compound.

15. The liquid crystal composition according to claim 1, comprising a polymerizable compound.

16. A device used for phase control of an electromagnetic wave signal with any frequency of 1 MHz to 400 THz containing the liquid crystal composition according to claim 1.
